(19) United States
(12) Patent Application Publication
(10) Pub. No.: US 2024/0048902 A1
(43) Pub. Date: Feb. 8, 2024

(54) Pair Direction Selection Based on Dominant Audio Direction

(71) Applicant: Nokia Technologies Oy, Espoo (FI)

(72) Inventors: Miikka Tapani Vilermo, Siuro (FI); Lasse Juhani Laaksonen, Tampere (FI); Arto Juhani Lehtiniemi, Lempaala (FI); Mikko Tapio Tammi, Tampere (FI)

(21) Appl. No.: 18/226,826

(22) Filed: Jul. 27, 2023

(30) Foreign Application Priority Data
Jul. 27, 2022 (GB) 2210984.7

(51) Int. Cl. H04R 3/00; H04R 1/40

(52) U.S. Cl. CPC H04R 3/005; H04R 1/406

(57) ABSTRACT

A method including: obtaining at least three microphone audio signals, wherein the microphone audio signals are associated with microphones with a location relative to an apparatus on which the microphones are located; analysing the at least three microphone audio signals to determine at least one metadata directional parameter; generating a first audio signal and a second audio signal based on at least one of the at least three microphone audio signals and the at least one metadata directional parameter; and outputting and/or storing the first audio signal, the second audio signal and the at least one metadata directional parameter, such that the first audio signal, the second audio signal, and the at least one metadata directional parameter enable a generation of an output audio signal with an adjustable audio focusing.

### FIELD

The present application relates to apparatus and methods for microphone pair or focused audio pair direction selection based on dominant audio direction for focusable spatial audio signal.

### BACKGROUND

Parametric spatial audio systems can be configured to store and transmit audio signal with associated metadata. The metadata describes spatial (and non-spatial) characteristics of the audio signal. The audio signals and metadata together can be used to render a spatial audio signal, typically for many different playback devices e.g. headphones, stereo speakers, 5.1 speakers, homepods.

The metadata typically comprises direction parameters (azimuth, elevation) and ratio parameters (direct-to-ambience ratio i.e. D/A ratio). Direction parameters describe sound source directions typically in time-frequency tiles. Ratio parameters describe the diffuseness of the audio signal i.e. the ratio of direct energy to diffuse energy also in time-frequency tiles. These parameters are psychoacoustically the most important in creating a spatially correct sounding audio to a human listener.

There may be one, two or more audio signals transmitted. A single audio signal with metadata is enough for many use cases, however, the nature of diffuseness and other fine details are only preserved if a stereo signal is transmitted. The difference between the left and right signals contains information about the details of the acoustic space. The more coarse spatial characteristics that are already described in the metadata (direction, D/A ratio) do not necessarily need to be correct in the transmitted audio signals, because the metadata is used to render these characteristics correctly in the decoder regardless of what they are in the audio signals. For backwards compatibility, all spatial characteristics should be correct also for the transmitted audio signals because legacy decoders ignore the metadata and only play the audio signals.

Furthermore audio focus is an audio processing method where sound sources in a direction are amplified with respect to sound sources in other directions. Typically, known methods such as beamforming or spatial filtering are employed. Beamforming and spatial filtering approaches both require knowledge about sound directions. These can typically be only estimated if the original microphone signals from known locations are present.

### SUMMARY

There is provided according to a first aspect an a method for generating spatial audio signals, the method comprising: obtaining at least three microphone audio signals, wherein the microphone audio signals are associated with microphones with a location relative to an apparatus on which the microphones are located; analysing the at least three microphone audio signals to determine at least one metadata directional parameter; generating a first audio signal and a second audio signal based on at least one of the at least three microphone audio signals and the at least one metadata directional parameter; and outputting and/or storing the first audio signal, the second audio signal and the at least one metadata directional parameter, such that the first audio signal, the second audio signal, and the at least one metadata directional parameter enable a generation of an output audio signal with an adjustable audio focussing.

Generating the first audio signal and the second audio signal based on at least one of the at least three microphone audio signals and the at least one metadata directional parameter may comprise: selecting a first of the at least three microphone audio signals to generate the first audio signal, the selected first of the at least three microphone audio signals with a location relative to the apparatus closest to the at least one metadata directional parameter; and selecting a second of the at least three microphone audio signals to generate the second audio signal, the selected second of the at least three microphone audio signals with a location relative to the apparatus furthest from the at least one metadata directional parameter.

Generating the first audio signal and the second audio signal based on at least one of the at least three microphone audio signals and the at least one metadata directional parameter may comprise: generating the first audio signal from a mix of the at least three microphone audio signals, the mix of the at least three microphone audio signals having a focus direction closest to the at least one metadata directional parameter; and generating the first audio signal from a second mix of the at least three microphone audio signals, the second mix of the at least three microphone audio signals having a focus direction furthest from the at least one metadata directional parameter.

Generating the first audio signal may comprise generating the first audio signal as an additive combination of the second mix of the at least three microphone audio signals and a panning of the mix of the at least three microphone audio signals to a left channel direction based on the at least one metadata directional parameter.

Generating the second output audio signal may comprise generating the second output audio signal as a subtractive combination of the second mix of the at least three microphone audio signals and a panning of the mix of the at least three microphone audio signals to a right channel direction based on the at least one metadata directional parameter.

According to a second aspect there is provided a method for processing spatial audio signals, the method comprising: obtaining a first audio signal, a second audio signal, and at least one metadata directional parameter; obtaining a desired focus directional parameter; generating a focus audio signal towards the desired focus directional parameter value, the focus audio signal based on the desired focus directional parameter, the at least one metadata directional parameter, the first audio signal and the second audio signal; and generating at least one output audio signal based on the focus audio signal.

Prior to generating the focus audio signal the method may comprise: de-panning the first audio signal; and de-panning the second audio signal, wherein generating the focus audio signal may comprise generating the focus audio signal based on a combination of the de-panned first audio signal and the de-panned second audio.

Generating at least one output audio signal based on the focus audio signal may comprise: generating a first output audio signal based on a combination of the focus audio signal and the first audio signal; and generating a second output audio signal based on a combination of the focus audio signal and the second audio signal.

Generating a focus audio signal towards the desired focus directional parameter value, the focus audio signal based on the desired focus directional parameter, the at least one metadata directional parameter, the first audio signal and the second audio signal may comprise: where the difference between the at least one metadata directional parameter value and the desired focus directional parameter value is less than a threshold value the focus audio signal is a selection of one of the first audio signal or the second audio signal; where the difference between the at least one metadata directional parameter value and the desired focus directional parameter value is greater than a further threshold value the focus audio signal is a selection of the other of the first audio signal or the second audio signal; and where the difference between the at least one metadata directional parameter value and the desired focus directional parameter value is less than the further threshold value and more than the threshold value the focus audio signal is a mix of the first audio signal or the second audio signal.

According to a third aspect there is provided an apparatus comprising means configured to: obtain at least three microphone audio signals, wherein the microphone audio signals are associated with microphones with a location relative to the apparatus on which the microphones are located; analyse the at least three microphone audio signals to determine at least one metadata directional parameter; generate a first audio signal and a second audio signal based on at least one of the at least three microphone audio signals and the at least one metadata directional parameter; and output and/or store the first audio signal, the second audio signal and the at least one metadata directional parameter, such that the first audio signal, the second audio signal, and the at least one metadata directional parameter enable a generation of an output audio signal with an adjustable audio focussing.

The means configured to generate the first audio signal and the second audio signal based on at least one of the at least three microphone audio signals and the at least one metadata directional parameter may be configured to: select a first of the at least three microphone audio signals to generate the first audio signal, the selected first of the at least three microphone audio signals with a location relative to the apparatus closest to the at least one metadata directional parameter; and select a second of the at least three microphone audio signals to generate the second audio signal, the selected second of the at least three microphone audio signals with a location relative to the apparatus furthest from the at least one metadata directional parameter.

The means configured to generate the first audio signal and the second audio signal based on at least one of the at least three microphone audio signals and the at least one metadata directional parameter may be configured to: generate the first audio signal from a mix of the at least three microphone audio signals, the mix of the at least three microphone audio signals having a focus direction closest to the at least one metadata directional parameter; and generate the first audio signal from a second mix of the at least three microphone audio signals, the second mix of the at least three microphone audio signals having a focus direction furthest from the at least one metadata directional parameter.

The means configured to generate the first audio signal may be configured to generate the first audio signal as an additive combination of the second mix of the at least three microphone audio signals and a panning of the mix of the at least three microphone audio signals to a left channel direction based on the at least one metadata directional parameter.

The means configured to generate the second output audio signal may be configured to generate the second output audio signal as a subtractive combination of the second mix of the at least three microphone audio signals and a panning of the mix of the at least three microphone audio signals to a right channel direction based on the at least one metadata directional parameter.

According to a fourth aspect there is provided an apparatus comprising means configured to: obtain a first audio signal, a second audio signal, and at least one metadata directional parameter; obtain a desired focus directional parameter; generate a focus audio signal towards the desired focus directional parameter value, the focus audio signal based on the desired focus directional parameter, the at least one metadata directional parameter, the first audio signal and the second audio signal; and generate at least one output audio signal based on the focus audio signal.

Prior to generating the focus audio signal the means may be configured to: de-panning the first audio signal; and de-panning the second audio signal, wherein the means configured to generate the focus audio signal may be configured to generate the focus audio signal based on a combination of the de-panned first audio signal and the de-panned second audio.

The means configured to generate at least one output audio signal based on the focus audio signal may be configured to: generate a first output audio signal based on a combination of the focus audio signal and the first audio signal; and generate a second output audio signal based on a combination of the focus audio signal and the second audio signal.

The means configured to generate a focus audio signal towards the desired focus directional parameter value, the focus audio signal based on the desired focus directional parameter, the at least one metadata directional parameter, the first audio signal and the second audio signal may be configured to: where the difference between the at least one metadata directional parameter value and the desired focus directional parameter value is less than a threshold value the focus audio signal is a selection of one of the first audio signal or the second audio signal; where the difference between the at least one metadata directional parameter value and the desired focus directional parameter value is greater than a further threshold value the focus audio signal is a selection of the other of the first audio signal or the second audio signal; and where the difference between the at least one metadata directional parameter value and the desired focus directional parameter value is less than the further threshold value and more than the threshold value the focus audio signal is a mix of the first audio signal or the second audio signal.

According to a fifth aspect there is provided an apparatus comprising: at least one processor and at least one memory storing instructions that when executed by the at least one processor cause the apparatus at least to: obtain at least three microphone audio signals, wherein the microphone audio signals are associated with microphones with a location relative to an apparatus on which the microphones are located; analyse the at least three microphone audio signals to determine at least one metadata directional parameter; generate a first audio signal and a second audio signal based on at least one of the at least three microphone audio signals and the at least one metadata directional parameter; and output and/or store the first audio signal, the second audio signal and the at least one metadata directional parameter, such that the first audio signal, the second audio signal, and the at least one metadata directional parameter enable a generation of an output audio signal with an adjustable audio focussing.

The apparatus caused to generate the first audio signal and the second audio signal based on at least one of the at least three microphone audio signals and the at least one metadata directional parameter may be caused to: select a first of the at least three microphone audio signals to generate the first audio signal, the selected first of the at least three microphone audio signals with a location relative to the apparatus closest to the at least one metadata directional parameter; and select a second of the at least three microphone audio signals to generate the second audio signal, the selected second of the at least three microphone audio signals with a location relative to the apparatus furthest from the at least one metadata directional parameter.

The apparatus caused to generate the first audio signal and the second audio signal based on at least one of the at least three microphone audio signals and the at least one metadata directional parameter may be caused to: generate the first audio signal from a mix of the at least three microphone audio signals, the mix of the at least three microphone audio signals having a focus direction closest to the at least one metadata directional parameter; and generate the first audio signal from a second mix of the at least three microphone audio signals, the second mix of the at least three microphone audio signals having a focus direction furthest from the at least one metadata directional parameter.

The apparatus caused to generate the first audio signal may be caused to generate the first audio signal as an additive combination of the second mix of the at least three microphone audio signals and a panning of the mix of the at least three microphone audio signals to a left channel direction based on the at least one metadata directional parameter.

The apparatus caused to generate the second output audio signal may be caused to generate the second output audio signal as a subtractive combination of the second mix of the at least three microphone audio signals and a panning of the mix of the at least three microphone audio signals to a right channel direction based on the at least one metadata directional parameter.

According to a sixth aspect there is provided an apparatus comprising: at least one processor and at least one memory storing instructions that when executed by the at least one processor cause the apparatus at least to: obtain a first audio signal, a second audio signal, and at least one metadata directional parameter; obtain a desired focus directional parameter; generate a focus audio signal towards the desired focus directional parameter value, the focus audio signal based on the desired focus directional parameter, the at least one metadata directional parameter, the first audio signal and the second audio signal; and generate at least one output audio signal based on the focus audio signal.

Prior to generating the focus audio signal the apparatus may be caused to: de-panning the first audio signal; and de-panning the second audio signal, wherein the apparatus caused to generate the focus audio signal may be caused to generate the focus audio signal based on a combination of the de-panned first audio signal and the de-panned second audio.

The apparatus caused to generate at least one output audio signal based on the focus audio signal may be caused to: generate a first output audio signal based on a combination of the focus audio signal and the first audio signal; and generate a second output audio signal based on a combination of the focus audio signal and the second audio signal.

The apparatus caused to generate a focus audio signal towards the desired focus directional parameter value, the focus audio signal based on the desired focus directional parameter, the at least one metadata directional parameter, the first audio signal and the second audio signal may be caused to: where the difference between the at least one metadata directional parameter value and the desired focus directional parameter value is less than a threshold value the focus audio signal is a selection of one of the first audio signal or the second audio signal; where the difference between the at least one metadata directional parameter value and the desired focus directional parameter value is greater than a further threshold value the focus audio signal is a selection of the other of the first audio signal or the second audio signal; and where the difference between the at least one metadata directional parameter value and the desired focus directional parameter value is less than the further threshold value and more than the threshold value the focus audio signal is a mix of the first audio signal or the second audio signal.

According to a seventh aspect there is provided an apparatus comprising: obtaining circuitry configured to obtain at least three microphone audio signals, wherein the microphone audio signals are associated with microphones with a location relative to the apparatus on which the microphones are located; analysing circuitry configured to analyse the at least three microphone audio signals to determine at least one metadata directional parameter; generating circuitry configured to generate a first audio signal and a second audio signal based on at least one of the at least three microphone audio signals and the at least one metadata directional parameter; and outputting and/or storing circuitry configured to output and/or store the first audio signal, the second audio signal and the at least one metadata directional parameter, such that the first audio signal, the second audio signal, and the at least one metadata directional parameter enable a generation of an output audio signal with an adjustable audio focussing.

According to an eighth aspect there is provided an apparatus for processing spatial audio signals, the apparatus comprising: obtaining circuitry configured to obtain a first audio signal, a second audio signal, and at least one metadata directional parameter; obtaining circuitry configured to obtain a desired focus directional parameter; generating circuitry configured to generate a focus audio signal towards the desired focus directional parameter value, the focus audio signal based on the desired focus directional parameter, the at least one metadata directional parameter, the first audio signal and the second audio signal; and generating circuitry configured to generate at least one output audio signal based on the focus audio signal.

According to a ninth aspect there is provided a computer program comprising instructions [or a computer readable medium comprising program instructions] for causing an apparatus to perform at least the following: obtaining at least three microphone audio signals, wherein the microphone audio signals are associated with microphones with a location relative to the apparatus on which the microphones are located; analysing the at least three microphone audio signals to determine at least one metadata directional parameter; generating a first audio signal and a second audio signal based on at least one of the at least three microphone audio signals and the at least one metadata directional parameter; and outputting and/or storing the first audio signal, the second audio signal and the at least one metadata directional parameter, such that the first audio signal, the second audio signal, and the at least one metadata directional parameter enable a generation of an output audio signal with an adjustable audio focussing.

According to a tenth aspect there is provided a computer program comprising instructions [or a computer readable medium comprising program instructions] for causing an apparatus to perform at least the following: obtaining a first audio signal, a second audio signal, and at least one metadata directional parameter; obtaining a desired focus directional parameter; generating a focus audio signal towards the desired focus directional parameter value, the focus audio signal based on the desired focus directional parameter, the at least one metadata directional parameter, the first audio signal and the second audio signal; and generating at least one output audio signal based on the focus audio signal.

According to an eleventh aspect there is provided a non-transitory computer readable medium comprising program instructions for causing an apparatus to perform at least the following: obtaining at least three microphone audio signals, wherein the microphone audio signals are associated with microphones with a location relative to the apparatus on which the microphones are located; analysing the at least three microphone audio signals to determine at least one metadata directional parameter; generating a first audio signal and a second audio signal based on at least one of the at least three microphone audio signals and the at least one metadata directional parameter; and outputting and/or storing the first audio signal, the second audio signal and the at least one metadata directional parameter, such that the first audio signal, the second audio signal, and the at least one metadata directional parameter enable a generation of an output audio signal with an adjustable audio focussing.

According to a twelfth aspect there is provided a non-transitory computer readable medium comprising program instructions for causing an apparatus to perform at least the following: obtaining a first audio signal, a second audio signal, and at least one metadata directional parameter; obtaining a desired focus directional parameter; generating a focus audio signal towards the desired focus directional parameter value, the focus audio signal based on the desired focus directional parameter, the at least one metadata directional parameter, the first audio signal and the second audio signal; and generating at least one output audio signal based on the focus audio signal.

According to a thirteenth aspect there is provided an apparatus comprising: means for obtaining at least three microphone audio signals, wherein the microphone audio signals are associated with microphones with a location relative to the apparatus on which the microphones are located; means for analysing the at least three microphone audio signals to determine at least one metadata directional parameter; means for generating a first audio signal and a second audio signal based on at least one of the at least three microphone audio signals and the at least one metadata directional parameter; and means for outputting and/or storing the first audio signal, the second audio signal and the at least one metadata directional parameter, such that the first audio signal, the second audio signal, and the at least one metadata directional parameter enable a generation of an output audio signal with an adjustable audio focussing.

According to a fourteenth aspect there is provided an apparatus comprising: means for obtaining a first audio signal, a second audio signal, and at least one metadata directional parameter; means for obtaining a desired focus directional parameter; means for generating a focus audio signal towards the desired focus directional parameter value, the focus audio signal based on the desired focus directional parameter, the at least one metadata directional parameter, the first audio signal and the second audio signal; and means for generating at least one output audio signal based on the focus audio signal.

According to a fifteenth aspect there is provided a computer readable medium comprising program instructions for causing an apparatus to perform at least the following: obtaining at least three microphone audio signals, wherein the microphone audio signals are associated with microphones with a location relative to the apparatus on which the microphones are located; analysing the at least three microphone audio signals to determine at least one metadata directional parameter; generating a first audio signal and a second audio signal based on at least one of the at least three microphone audio signals and the at least one metadata directional parameter; and outputting and/or storing the first audio signal, the second audio signal and the at least one metadata directional parameter, such that the first audio signal, the second audio signal, and the at least one metadata directional parameter enable a generation of an output audio signal with an adjustable audio focussing.

According to a sixteenth aspect there is provided a computer readable medium comprising program instructions for causing an apparatus to perform at least the following: obtaining a first audio signal, a second audio signal, and at least one metadata directional parameter; obtaining a desired focus directional parameter; generating a focus audio signal towards the desired focus directional parameter value, the focus audio signal based on the desired focus directional parameter, the at least one metadata directional parameter, the first audio signal and the second audio signal; and generating at least one output audio signal based on the focus audio signal.

According to a seventeenth aspect there is provided an apparatus comprising: an input configured to obtain at least three microphone audio signals, wherein the microphone audio signals are associated with microphones with a location relative to the apparatus on which the microphones are located; an analyser configured to analyse the at least three microphone audio signals to determine at least one metadata directional parameter; a generator configured to generate a first audio signal and a second audio signal based on at least one of the at least three microphone audio signals and the at least one metadata directional parameter; and an output configured to output and/or a storage configured to store the first audio signal, the second audio signal and the at least one metadata directional parameter, such that the first audio signal, the second audio signal, and the at least one metadata directional parameter enable a generation of an output audio signal with an adjustable audio focussing.

According to an eighteenth aspect there is provided an apparatus comprising: an input configured to obtain a first audio signal, a second audio signal, and at least one metadata directional parameter; a further input configured to obtain a desired focus directional parameter; a generator configured to generate a focus audio signal towards the desired focus directional parameter value, the focus audio signal based on the desired focus directional parameter, the at least one metadata directional parameter, the first audio signal and the second audio signal; and an output generator configured to generate at least one output audio signal based on the focus audio signal.

An apparatus comprising means for performing the actions of the method as described above.

An apparatus configured to perform the actions of the method as described above.

A computer program comprising program instructions for causing a computer to perform the method as described above.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For a better understanding of the present application, reference will now be made by way of example to the accompanying drawings in which:

FIG. 1 shows schematically a system of apparatus suitable for implementing some embodiments;

FIG. 2 shows schematically an example encoder using microphone selection as shown in the system of apparatus as shown in FIG. 1 according to some embodiments;

FIG. 3 shows a flow diagram of the operation of the example encoder shown in FIG. 2 according to some embodiments;

FIG. 4 shows schematically a further example encoder using microphone selection as shown in the system of apparatus as shown in FIG. 1 according to some embodiments;

FIG. 5 shows a flow diagram of the operation of the further example encoder shown in FIG. 4 according to some embodiments;

FIGS. 6 to 9 show example microphone selections for sound objects;

FIG. 10 shows a flow diagram of the operation of the example encoder shown in FIG. 2 according to some embodiments;

FIG. 11 shows schematically an example encoder using focussing as shown in the system of apparatus as shown in FIG. 1 according to some embodiments;

FIG. 12 shows a flow diagram of the operation of the example encoder shown in FIG. 11 according to some embodiments;

FIG. 13 shows schematically a further example encoder using focussing as shown in the system of apparatus as shown in FIG. 1 according to some embodiments;

FIG. 14 shows a flow diagram of the operation of the further example encoder shown in FIG. 13 according to some embodiments;

FIGS. 15 and 16 show example microphone focussing for sound objects;

FIG. 17 shows a flow diagram of the operation of the example encoder shown in FIG. 11 according to some embodiments;

FIG. 18 shows schematically an example decoder using microphone selection as shown in the system of apparatus as shown in FIG. 1 according to some embodiments;

FIG. 19 shows a flow diagram of the operation of the example decoder shown in FIG. 18 according to some embodiments;

FIG. 20 shows schematically an example decoder using microphone selection as shown in the system of apparatus as shown in FIG. 1 according to some embodiments;

FIG. 21 shows a flow diagram of the operation of the example decoder shown in FIG. 20 according to some embodiments;

FIG. 22 shows an example gain function for modifying audio signals according to some embodiments;

FIG. 23 shows a flow diagram of the operation of the example decoder shown in FIG. 20 according to some embodiments;

FIG. 24 shows schematically an example decoder using focussing as shown in the system of apparatus as shown in FIG. 1 according to some embodiments;

FIG. 25 shows schematically an example decoder using focussing selection as shown in the system of apparatus as shown in FIG. 1 according to some embodiments;

FIG. 26 shows an example gain function for modifying audio signals according to some embodiments;

FIG. 27 shows a flow diagram of the operation of the example decoder shown in FIG. 24 according to some embodiments; and

FIG. 28 shows an example device suitable for implementing the apparatus shown in previous figures.

### EMBODIMENTS OF THE APPLICATION

The following describes in further detail suitable apparatus and possible mechanisms for microphone pair or focused audio pair direction selection based on dominant audio direction for focusable spatial audio signal.

As described above parametric spatial audio systems can be configured to store and transmit audio signal together with metadata. Additionally audio focus or audio focussing is an audio processing method where sound sources in a direction (or within a defined range) are amplified with respect to sound sources in other directions. Although an audio focus or focussing approach is discussed herein it would be considered that an audio de-focus or defocussing occurs where sound sources in a direction (or within a defined range) are diminished or reduced with respect to sound sources in other directions could be exploited in a similar manner to that described in the following).

Typical uses for audio focus are:
telecommunications where a user voice is amplified compared to background sounds;
speech recognition, where voice is amplified to minimize word error rate;
sound source amplification in the direction of camera that records video with audio;
an off-camera focus where listener is watching a video and wants to focus to some other direction than camera direction. For example the person who recorded the video wants the audio to focus to their child whereas the person watching the video might want to focus the audio to the listener's child away from the camera axis;
a focus-switch where a listener may want to focus to different audio objects at different times watching a video; and
a teleconference or live meeting application where different listeners of a meeting may want to focus to different speakers.

Audio representations where a listener is able to freely choose where to focus audio have previously required a large number of pre-focused audio signals that are focused to all possible desirable directions. These representations require a large number of bits to be stored or transmitted over the network. In the embodiments as discussed herein the number of bits required to store or transmit the representation are reduced by limiting the number of focus directions based on the direction of the dominant sound source.

In some embodiments there is provided a listener (user) or device focusable audio playback where capture device adaptively chooses two microphones to use based on surrounding sound source directions and stores/transmits a spatial audio signal created from the selected microphones to enable audio focus during playback with only two transmitted audio signals+metadata.

In other words in some embodiments there is provided apparatus and methods that:
capture audio using at least three microphones;
determines a dominant sound source direction using these captured audio signals;
selects the two microphones that are closest to a line from the device towards the dominant sound source direction i.e. so that the two microphones and the sound source are approximately on the same line;
creates an audio signal using the selected two microphones and spatial metadata; and
transmits/stores the created audio signal.

The microphone selection enables audio focusing for the stored audio signal.

The advantage of such embodiments enables the listener (or listening or playback apparatus) to change audio focus without requiring significantly more bits as would be required to create a focusable audio signal using known methods.

Furthermore in some embodiments the capture device or apparatus is configured to adaptively choose a focus direction based on surrounding sound source directions and stores/transmits an audio signal created from a focus audio signals (in the selected direction) and an anti-focus signal to enable audio focus during playback with only two transmitted audio signals+metadata.

In such embodiments the apparatus is configured to:
detect dominant sound source direction in each time-frequency tiles of captured audio signals;
create two audio signals, a first audio signal that is focused towards the dominant sound source direction in each tile and a second audio signal that is focused away from the dominant sound source direction in each tile;
create a parametric spatial audio signal using the focused two audio signals and spatial metadata; and
transmit/store the spatial audio signal.

In such embodiments the listener (or the apparatus) can change audio focus in the receiver or listening apparatus without requiring more bits to create a user focusable audio signal than necessary.

Additionally in some embodiments there is provided an apparatus configured to provide a listener or user modifiable audio playback where the apparatus is configured to retrieve or receive two audio signals and direction metadata, the apparatus can then be configured to emphasize one of the signals based on the metadata and listener (user) desired focus direction and therefore achieves user selectable audio focus during playback with only two received audio signals and metadata.

In such embodiments the apparatus is configured to play back an audio signal that can be focused towards any direction specified by the device user. (In some embodiments the direction may be determined by the playback apparatus, typically after analysing the spatial audio or related video content.) The audio signal contains at least two audio channels and at least direction metadata. When the listener (user) wants to focus towards the same direction as is currently in the parametric spatial audio metadata, then one of the audio channels is emphasized, and a channel audio signal is selected based on the direction in the metadata. In some embodiments when the listener wants to focus away from the direction that is currently in the parametric spatial audio metadata, then the other audio channel audio signal is emphasized. When the listener (user) wants to focus to other directions than what is currently in the parametric spatial audio metadata, then the first and second channel audio signals are mixed.

In such embodiments the listener (user) is able to change audio focus in the receiver without requiring more bits in order to create a user focusable audio signal.

In some embodiments a listener (user) modifiable audio playback apparatus is configured to receive two audio signals and direction metadata and emphasize one of the signals based on the metadata and user desired focus direction. In such embodiments user selectable audio focus during playback is enabled with only two received audio signals and metadata.

Thus in some embodiments the apparatus is configured to play back an audio signal that can be focused towards any direction specified by the listener (user). In some embodiments the direction may be determined by the device, typically after analysing the spatial audio or related video content. The apparatus is configured to:
receive or retrieve an audio signal contains at least two audio channels and at least direction metadata;
If a listener wants to focus towards the same direction as is currently in the parametric spatial audio metadata, then one of the channel audio signals is emphasized. The channel audio signal is selected based on the direction in the metadata.

If a listener (user) wants to focus away from the direction that is currently in the parametric spatial audio metadata, then the other channel audio signal is emphasized.

If a listener (user) wants to focus to other directions then what is currently in the parametric spatial audio metadata, then the first and second channel audio signals are mixed.

In such embodiments the listener is able to change audio focus in the receiver without requiring more bits to create a user focusable audio signal using prior art methods.

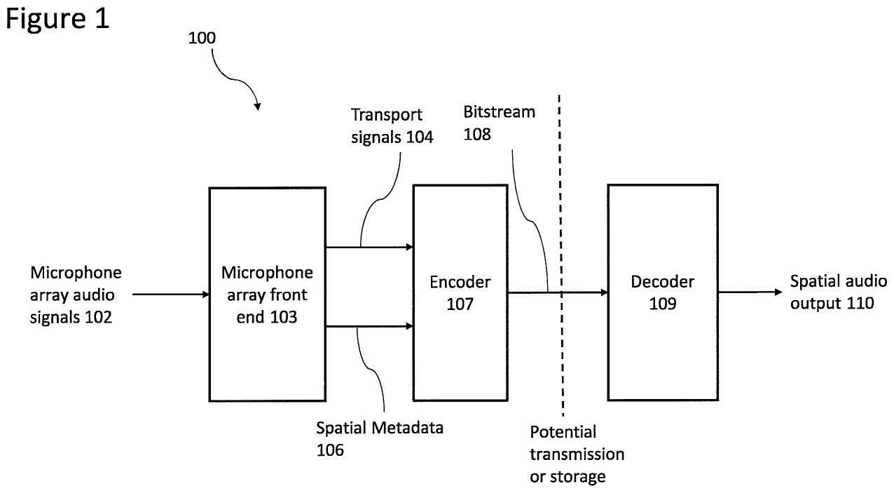

Embodiments will be described with respect to an example capture (or encoder/analyser) and playback (or decoder/synthesizer) apparatus or system 100 as shown in FIG. 1. In the following example the audio signal input is one from a microphone array, however it would be appreciated that the audio input can be any suitable audio input format and the description hereafter details, where differences in the processing occurs when a differing input format is employed.

The system 100 is shown with capture part and a playback (decoder/synthesizer) part.

The capture part in some embodiments comprises a microphone array audio signals input 102. The input audio signals can be from any suitable source, for example: two or more microphones mounted on a mobile phone, other microphone arrays, e.g., B-format microphone or Eigenmike. In some embodiments, as mentioned above, the input can be any suitable audio signal input such as Ambisonic signals, e.g., first-order Ambisonics (FOA), higher-order Ambisonics (HOA) or Loudspeaker surround mix and/or objects.

The microphone array audio signals input 102 may be provided to a microphone array front end 103. The microphone array front end in some embodiments is configured to implement an analysis processor functionality configured to generate or determine suitable (spatial) metadata associated with the audio signals and implement a suitable transport signal generator functionality to generate transport audio signals.

The analysis processor functionality is thus configured to perform spatial analysis on the input audio signals yielding suitable spatial metadata 106 in frequency bands. For all of the aforementioned input types, there exists known methods to generate suitable spatial metadata, for example directions and direct-to-total energy ratios (or similar parameters such as diffuseness, i.e., ambient-to-total ratios) in frequency bands. These methods are not detailed herein, however, some examples may comprise the performing of a suitable time-frequency transform for the input signals, and then in frequency bands when the input is a mobile phone microphone array, estimating delay-values between microphone pairs that maximize the inter-microphone correlation, and formulating the corresponding direction value to that delay (as described in GB Patent Application Number 1619573.7 and PCT Patent Application Number PCT/FI2017/050778), and formulating a ratio parameter based on the correlation value.

The metadata can be of various forms and in some embodiments comprise spatial metadata and other metadata. A typical parameterization for the spatial metadata is one direction parameter in each frequency band characterized as an azimuth value ϕ(k,n) value and elevation value θ(k,n) and an associated direct-to-total energy ratio in each frequency band r(k,n), where k is the frequency band index and n is the temporal frame index.

In some embodiments the parameters generated may differ from frequency band to frequency band. Thus, for example in band X all of the parameters are generated and transmitted, whereas in band Y only one of the parameters is generated and transmitted, and furthermore in band Z no parameters are generated or transmitted. A practical example of this may be that for some frequency bands such as the highest band some of the parameters are not required for perceptual reasons.

As such the output of the analysis processor functionality is (spatial) metadata 106 determined in time-frequency tiles. The (spatial) metadata 106 may involve directions and energy ratios in frequency bands but may also have any of the metadata types listed previously. The (spatial) metadata 106 can vary over time and over frequency.

In some embodiments the analysis functionality is implemented external to the system 100. For example, in some embodiments the spatial metadata associated with the input audio signals may be provided to an encoder 107 as a separate bit-stream. In some embodiments the spatial metadata may be provided as a set of spatial (direction) index values.

The microphone array front end 103, as described above is further configured to implement transport signal generator functionality, in order to generate suitable transport audio signals 104. The transport signal generator functionality is configured to receive the input audio signals, which may for example be the microphone array audio signals 102 and generate the transport audio signals 104. The transport audio signals may be a multi-channel, stereo, binaural or mono audio signal. The generation of transport audio signals 104 can be implemented using any suitable method.

In some embodiments the transport signals 104 are the input audio signals, for example the microphone array audio signals. The number of transport channels can also be any suitable number (rather than one or two channels as discussed in the examples).

In some embodiments the capture part may comprise an encoder 107. The encoder 107 can be configured to receive the transport audio signals 104 and the spatial metadata 106. The encoder 107 may furthermore be configured to generate a bitstream 108 comprising an encoded or compressed form of the metadata information and transport audio signals.

The encoder 107, for example, could be implemented as an IVAS encoder, or any other suitable encoder. The encoder 107, in such embodiments is configured to encode the audio signals and the metadata and form an IVAS bit stream.

This bitstream 108 may then be transmitted/stored as shown by the dashed line.

The system 100 furthermore may comprise a player or decoder 109 part. The player or decoder 109 is configured to receive, retrieve or otherwise obtain the bitstream 108 and from the bitstream generate suitable spatial audio signals 110 to be presented to the listener/listener playback apparatus.

The decoder 109 is therefore configured to receive the bitstream 108 and demultiplex the encoded streams and then decode the audio signals to obtain the transport signals and metadata.

The decoder 109 furthermore can be configured to, from the transport audio signals and the spatial metadata, produce the spatial audio signals output 110 for example a binaural audio signal that can be reproduced over headphones.

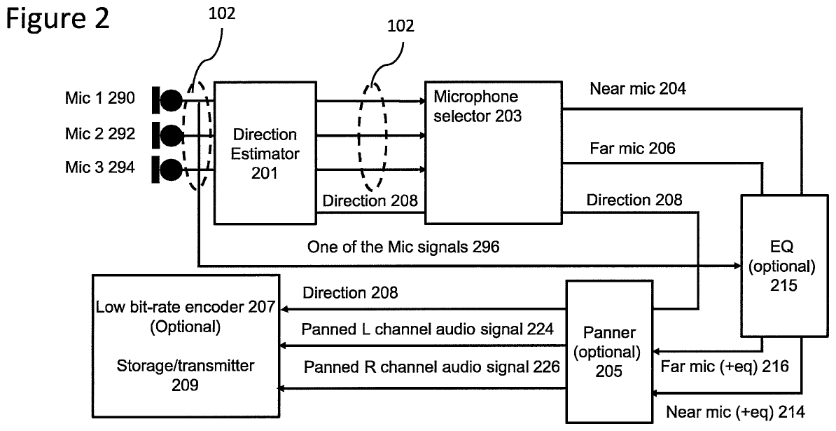

With respect to FIG. 2, there is shown the encoder side in further detail according to some embodiments.

In some embodiments, as shown in FIG. 2, there is shown a series of microphones as part of the microphone array: a first microphone, mic 1, 290 a second microphone mic 2, 292, and a third microphone, mic 3, 294 which are configured to generate the audio input 102 which is passed to a direction estimator 201. Although only 3 microphones are shown in the example shown in FIG. 2 some embodiments comprises a large number (e.g. 8) microphones that are at least approximately symmetrically placed around the device.

The direction estimator 201 can be considered to be part of the metadata generation operations as described above. The direction estimator 201 thus can be configured to output the microphone audio signals in the form of the audio input 102 and the direction values 208.

The direction estimate is an estimate of the dominant sound source direction. The direction estimation as indicated above is implemented in small time frequency tiles by framing the microphone signals in typically 20 ms frames, transforming the frames into frequency domain (using DFT (Discrete Fourier Transform), DCT (Discrete Cosine Transform) or filter banks like QMF (Quadrature Mirror Filter)), splitting the frequency domain signal into frequency bands and analysing the direction in the bands. These type of framed bands of audio are referred to as time-frequency tiles. The tiles are typically narrower in low frequencies and wider in higher frequencies and may follow for example third-octave bands or Bark bands or ERB bands (Equivalent Rectangular Bandwidth). Other methods such as filterbanks exist for creating similar tiles.

In some embodiments at least one dominant sound source direction α is estimated for each tile using any suitable method such as described above.

In the embodiments described herein processing can be (and typically is) implemented in time-frequency tiles. However, for the sake of clarity the following methods are described with respect to one range of frequencies and one time instant. For example typically there would be 20-50 tiles per time instant (=frame) and the number of time instants depends on the frame length and processed audio length.

In some embodiments the encoder part comprises a microphone selector 203 which is configured to obtain the audio input 102 and from these audio signals select a near microphone audio signal 204 and a far microphone audio signal 206. In some embodiments a simple method for selecting the near microphone audio signal 204 and far microphone audio signal 206 from the input microphone audio signals 103 is to determine a pair of microphones between which define an axis which is the closest to the determined direction and select the nearer microphone of the pair relative to the determined sound source direction to supply the near microphone audio signal 204 and select the further microphone of the pair relative to the determined sound source direction to supply the far microphone audio signal 206.

In other words the microphone selection makes one of the microphones a dominant sound source microphone with respect to sound sources in other directions. This is because the first, near, microphone is selected from the same side (as much as possible) as the dominant sound source direction and the second, far, microphone is from the opposite side of the device (as much as possible) and the apparatus or device body physically attenuates sounds that come to the first microphone from other sides than the one where the dominant sound source is.

It would be appreciated that the direction estimation result may change continuously as the dominant sound source may move continuously e.g. when there are multiple speakers around the device and the person talking (=dominant sound source) changes continuously or when the dominant sound source moves or the device moves. Also, the direction estimation may be different in different frequencies. Therefore, also the direction from which one channel amplifies sound sources changes continuously, the direction being the same as the estimated direction in the metadata.

Furthermore the near microphone audio signals and far microphone audio signals are mapped respectively to a left, L, channel audio signal and right, R, channel audio signal. This can be represented generally as
0°≤α<180° use near microphone audio signal as L channel audio signal and far microphone audio signal as R channel audio signal
−180°≤α<0° use near microphone audio signal as R channel audio signal and far microphone audio signal as L channel audio signal

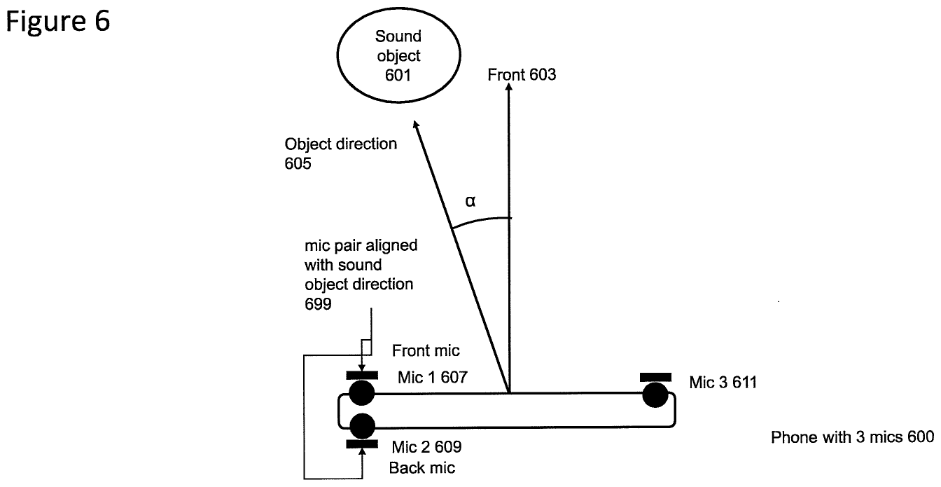

In some embodiments the selection is implemented according to the following system (and with respect to the examples described hereafter in FIGS. 6 to 9):
0°≤α<45° use near microphone audio signal (Mic 1 607) as the L channel audio signal and far microphone audio signal (Mic 2 609) as R channel audio signal
45°≤α<90° use near microphone audio signal (Mic 1 607) as L channel audio signal and far microphone audio signal (Mic 3 611) as R channel audio signal
90°≤α<135° use near microphone audio signal (Mic 2 609) as L channel audio signal and far microphone audio signal (Mic 3 611) as R channel audio signal
135°≤α<180° use near microphone audio signal (Mic 2 609) as L channel audio signal and far microphone audio signal (Mic 1 607) as R channel audio signal
−45°≤α<0° use near microphone audio signal (Mic 1 607) as R channel audio signal and far microphone audio signal (Mic 2 609) as L channel audio signal
−90°≤α<−45° use near microphone audio signal (Mic 3 611) as R channel audio signal and far microphone audio signal (Mic 2 609) as L channel audio signal
−135°≤α<−90° use near microphone audio signal (Mic 3 611) as R channel audio signal and far microphone audio signal (Mic 1 607) as L channel audio signal
−180°≤α<−135° use near microphone audio signal (Mic 2 609) as R channel audio signal and far microphone audio signal (Mic 1 607) as L channel audio signal

An example of these selection methods is shown in FIG. 6, which shows an example apparatus, a phone with 3 microphones 600. The phone 600 has a defined front direction 603 and a first front microphone 607 (a microphone located on the front face of the apparatus), a second front microphone 611 (another microphone located on the front face of the apparatus but near to the opposite end of the phone with respect to the first front microphone) and a back microphone 609 (a further microphone located on the back or rear face of the apparatus and shown in this example opposite the first front microphone).

Additionally there is shown in FIG. 6 a sound object 601 which has a direction α 605 relative to the front axis 603. When the direction is less than a defined angle (the angle defined by the physical dimensions of the apparatus and the relative microphone pair virtual angles) then the front microphone 607 is the ‘near microphone’ and the back microphone 611 is the ‘far microphone’ with reference to the microphone selection and audio signal selection. Furthermore as 0°≤α<45° the microphone selector can be configured to use near microphone audio signal (Mic 1 607) as the L channel audio signal and far microphone audio signal (Mic 2 609) as R channel audio signal.

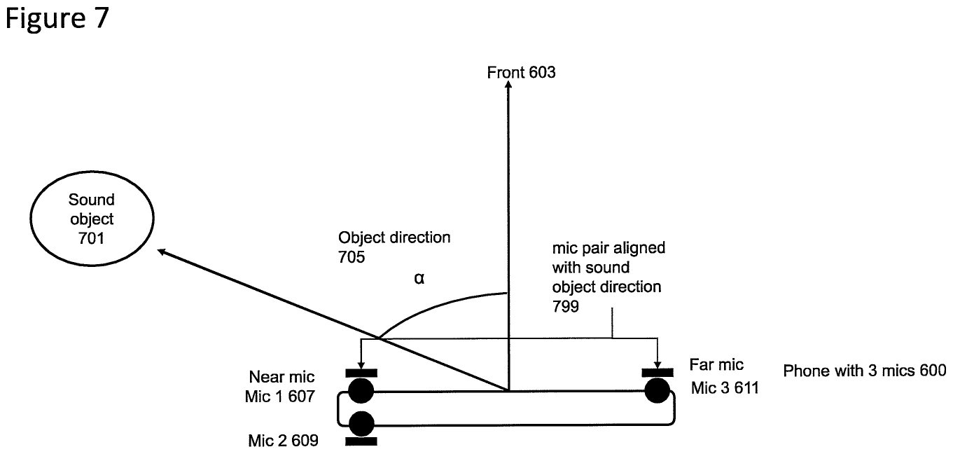

It would be understood that when the direction is more than a defined angle, such as shown in the example in FIG. 7, where the sound object 701 has an object direction 705 greater than the defined angle then the front microphone, microphone 1, 607 is the ‘near microphone’ and the other front microphone, microphone 3, 611 is the ‘far microphone’ as the angle formed by the pair of the microphones, microphone 1 607 and microphone 3 611 is closer to the determined sound object direction than the angle formed by the pair microphone 1 607 and microphone 2 609. In this example the selected audio signals are the near microphone audio signal 204, and which is the microphone 1 607 audio signal, and the far microphone audio signal 206 the microphone 3 611 audio signal. Additionally as 45°≤α<90° the microphone selector can be configured to use near microphone audio signal (Mic 1 607) as L channel audio signal and far microphone audio signal (Mic 3 611) as R channel audio signal.

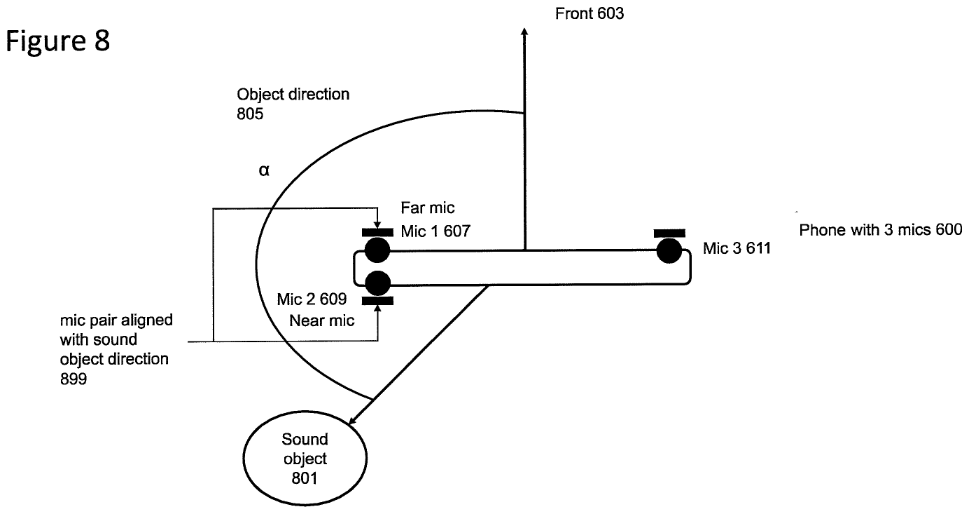

Furthermore, as shown in the example in FIG. 8, where there is a sound object 801 which has a direction 805 closer to the angle defined by the pair 899 of microphones, microphone 1 607 and microphone 2 609, then the front microphone, microphone 1 607, can be selected as the far microphone and the back microphone, microphone 2 609, as the near microphone as this microphone pair are more aligned with the sound object direction but the back microphone, microphone 2 809 is closer to the object. In this case 135°≤α<180° and the microphone selector can be configured to use near microphone audio signal (Mic 2 609) as L channel audio signal and far microphone audio signal (Mic 2 609) as R channel audio signal.

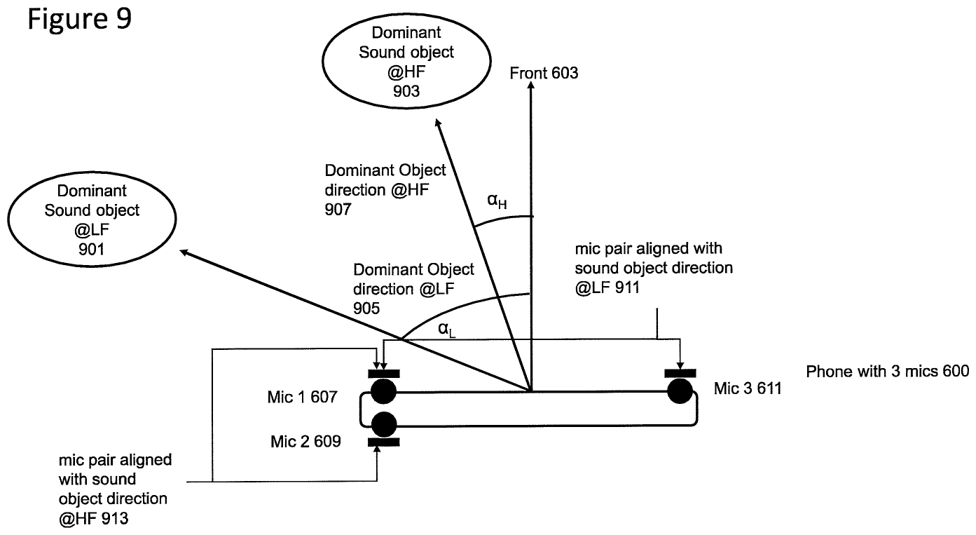

As shown in FIG. 9, there are shown two sound objects, a dominant sound object at low frequencies 901 which has a direction 905 closer to the angle defined by the pair 911 of microphones, microphone 1 607 and microphone 2 609, then the front microphone, microphone 1 607, can be selected as the near microphone and the other front microphone, microphone 3 611 can be selected as the far microphone for the low frequencies. Also with respect to the low frequency tiles as 45°≤α<90° the microphone selector can be configured to use near microphone audio signal (Mic 1 607) as L channel audio signal and far microphone audio signal (Mic 3 611) as R channel audio signal.

Additionally is shown a dominant sound object at high frequencies 903 which has a direction 907 closer to the angle defined by the pair 913 of microphones, microphone 1 607 and microphone 2 609, then the front microphone, microphone 1 607, can be selected as the near microphone and the back microphone, microphone 2 611 can be selected as the far microphone for the high frequencies. Thus with respect to the high frequency tiles as 0°≤α<45° the microphone selector can be configured to use near microphone audio signal (Mic 1 607) as the L channel audio signal and far microphone audio signal (Mic 2 609) as R channel audio signal.

The encoder part furthermore in some embodiments comprises an optional equalizer 215. The equalizer 215 is configured to obtain the near microphone audio signal 204, the far microphone audio signal 206 and furthermore one of the microphone audio signals 296.

The constant change of which microphone is used for which tile for which channel can cause annoying level changes in the L and R channel audio signals. This can in some embodiments be at least partially corrected by setting the level of L and R signals to be the same as a fixed reference microphone signal or signals. However, the setting of the L and R channel audio signals can be problematic. For example where a decoder apparatus wants to apply additional beamforming to the signals. Therefore, in some embodiments the equalizer 215 is configured to equalize the sum of L and R channel audio signals to a level of a fixed microphone signal. In implementing equalisation as described herein the original level differences between L and R channel audio signals are maintained and since beamforming is based on level (and phase) differences, the equalization does not destroy the possibility of beamforming.

Therefore, the L and R channel audio signals can be equalized so that a different gain value is applied in each tile however the gain value is the same for the corresponding tile in L and R channels. The gain values are selected so that the result sum of L and R channels (after the gain values are applied) has the same level (energy) as a reference microphone audio signal, for example microphone 1.

This level correction furthermore maintains audio focus performance achieved with microphone selection. Different sound sources are acoustically mixed at different levels in the selected microphone signals so that the first microphone has sound sources in the dominant sound source direction louder in the mixture than the second microphone.

The output of the far microphone (plus equalisation) audio signal 216 and the near microphone (plus equalisation) audio signal 214 can be passed to a panner 205.

In some embodiments the encoder part comprises (optionally) a panner 205 configured to obtain the far microphone (plus equalisation) audio signal 216 (which is also the mapped R channel audio signal) and the near microphone (plus equalisation) audio signal 214 (which is also the mapped L channel audio signal) and the direction values 208.

The panner is configured to modify the far microphone (plus equalisation) audio signal 216 and the near microphone (plus equalisation) audio signal 214 by an invertible panning process that makes the near mic/L channel audio signal 214 and far mic/R channel audio signal 216 into a spatial audio (stereo signal) with a panned left L channel audio signal 224 and panned right R channel audio signal 226

The panning takes the selected microphone signals based on estimated direction α so that the resulting spatial (typically stereo) signal keeps the spatial audio image such that the dominant sound source is in estimated direction α at least better than without the mixing and panning and also the diffuseness of the spatial audio image is retained. The aim is to improve the quality of the spatial audio image which may be originally poor because the selected microphones are in bad positions for generating the spatial audio signal.

The panner is configured to apply a panning which is reversible with the knowledge of side information, typically the direction α because during playback, the panning may need to be reversed to get access to the original microphone signals so that user may focus elsewhere.

In some embodiments the panning is implemented in time-frequency tiles like all other processing. The processing is the same inside the tile i.e. for all frequency bins in the frequency band from a time frame that defines the tile. This is because there is only one direction estimated for all the bins inside the tile.

In some embodiments the panning can be based on a common sine panning law.

$${L}_{pan} ( α ) = \frac{1}{2} sin ( α ) + \frac{1}{2}$$

$${R}_{p a n} ( α ) = \frac{1}{2} sin ( α + {180}^{∘} ) + \frac{1}{2}$$

In some embodiments the panner is configured to pan the near microphone signal xₙₑₐᵣ using estimated direction α and to use the far microphone signal x_{far} as a background signal that is evenly spread to both output channels L and R. Panning the near mic signal works because the near microphone captures more of the dominant sound source from direction α than the far microphone.

L=Lₚₐₙ(α)·xₙₑₐᵣ+x_{far}

R=Rₚₐₙ(α)·xₙₑₐᵣ−x_{far}

The panner 205 can then output the direction values 208, the panned left channel audio signal L 224 and the panned right channel audio signal R 226.

In some embodiments the encoder part further comprises a suitable low bit-rate encoder 207. This optionally is configured to encode the metadata and the panned left and right channel audio signals. The data may be low-bitrate encoded using codecs like mp3, AAC, IVAS etc.

Furthermore in some embodiments the encoder comprises a suitable storage/transmitter 209 configured to store and/or transmit the metadata and audio signals (which as shown herein can be encoded).

In some embodiments some beamforming parameters or other audio focus parameters may be generated and transmitted as metadata. These can be used during playback to focus audio towards dominant and opposite directions. For example a MVDR (Minimum Variance Distortionless Response) beamformer may be employed. The parameters may be transmitted once for all microphone pairs and focus directions or they may be transmitted in real time when a listener (user) initiates audio focus during playback. The beamforming parameters are typically phases and gains that are multiplied with the signals before summing them to achieve beamforming.

In some embodiments the beamforming parameters comprise a delay (phase) that describes the distance between the two selected microphones. It is understood that generating and transmitting beamforming parameters is not absolutely necessary, because the near microphone signal is already naturally (because of acoustic shadowing from the device) emphasizing the dominant sound source and the far microphone de-emphasizes the dominant sound source.

It would be understood that the encoder as described with respect to FIG. 2 shows elements which are pertinent to the understanding of the embodiments. Typically, an encoding or capture apparatus would be configured to employ other audio processing such as microphone equalization, gain compensation, noise cancellation, dynamic range compression analogue-to-digital transformation (and vice versa) etc.

Additionally in the embodiments described herein the focus is described as a 2D focus only on horizontal plane. However in some embodiments a 3D focus can be implemented where the microphones are not only on a horizontal plane and the apparatus is configured to select two microphones that aren't on a horizontal plane or focus towards directions outside horizontal plane. Typically, this would require an apparatus to comprise at least four microphones.

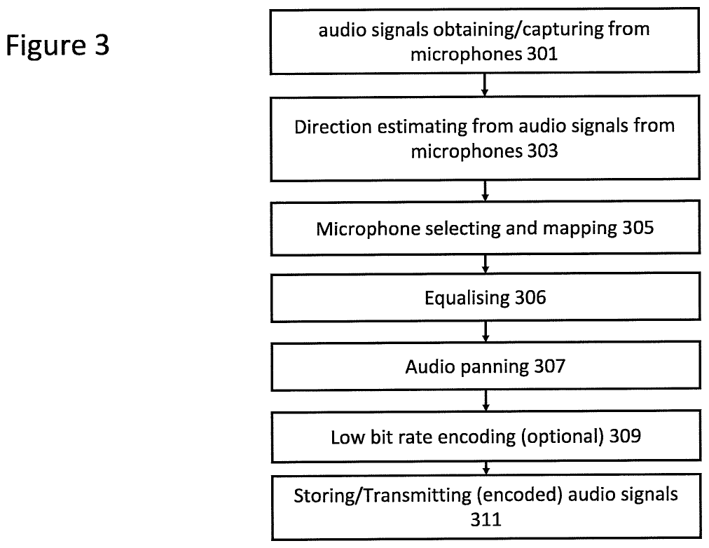

Thus with respect to FIG. 3 is shown a flow diagram of the operations which are implemented by the encoder part as shown in FIG. 1.

For example the operations comprise that of audio signals obtaining/capturing from microphones as shown in FIG. 3 by step 301.

Then the following operation is one of direction estimating from audio signals from microphones as shown in FIG. 3 by step 303.

The following operation is one of microphone selecting/mapping (based on the dominant sound source direction) as shown in FIG. 3 by step 305.

Then there is an optional operation of equalising the selected audio signals as shown in FIG. 3 by step 306.

Following on there can be an audio panning applied to the selected (and equalised) audio signals as shown in FIG. 3 by step 307.

There can be furthermore comprise an operation of low bit rate encoding which is optional as shown in FIG. 3 by step 309.

Finally with respect to the encoder side there is shown an operation of storing/transmitting (encoded) audio signals as shown in FIG. 3 by step 311.

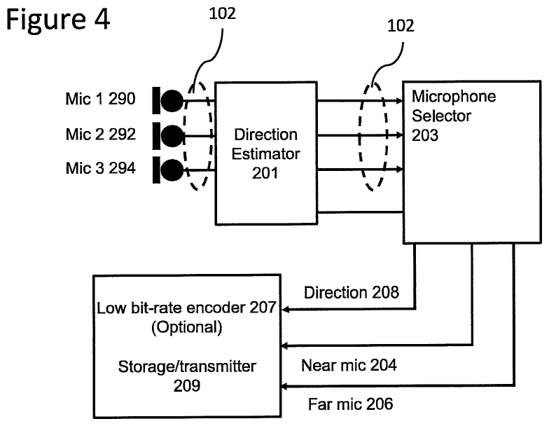

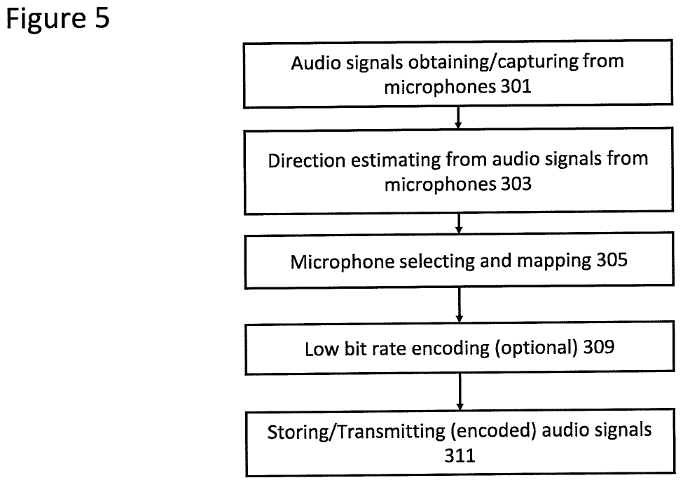

Furthermore is shown with respect to FIGS. 4 and 5 a ‘bare bones’ encoder part and the operations associated with the ‘bare bones’ encoder respectively.

Thus FIG. 4 shows the direction estimator 201, microphone selector and encoder (optional) 207 and storage/transmitter 209 as described above and FIG. 5 shows the operations of obtaining/capturing from microphones (step 301), direction estimating from audio signals from microphones (step 303), microphone selecting/mapping (step 305), low bit rate encoding (optional step 309) and storing/transmitting (encoded) audio signals (step 311).

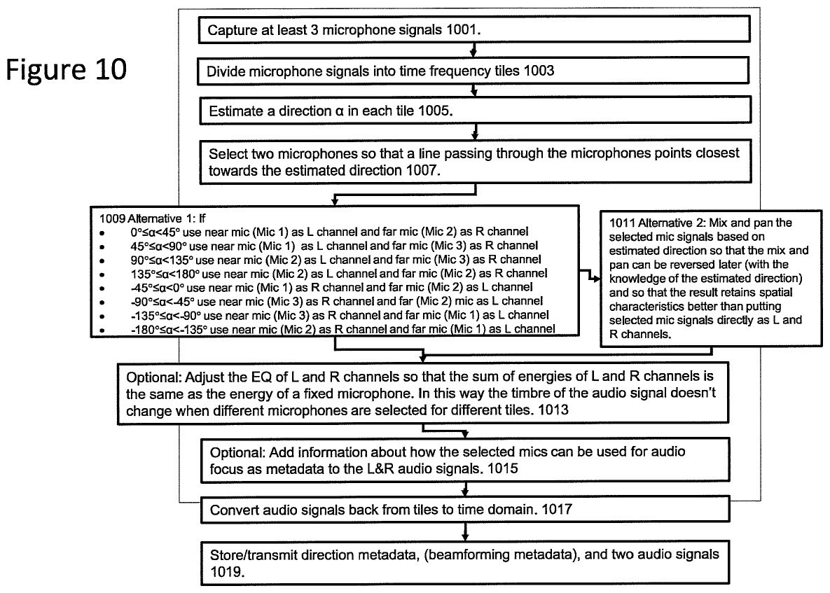

Furthermore with respect to FIG. 10 is shown in further detail an example set of operations employed by the apparatus according to some embodiments.

The first operation is to capture at least 3 microphone signals as shown in FIG. 10 by step 1001.

Then, having captured at least 3 microphone signals, divide the microphone signals into time frequency tiles as shown in FIG. 10 by step 1003.

Following this estimate a direction α in each tile as shown in FIG. 10 by step 1005.

Select two microphones so that a line passing through the microphones points closest towards the estimated direction as shown in FIG. 10 by step 1007.

In some embodiments the following mapping as shown in FIG. 10 by step 1009 can be implemented:

If
0°≤α<45° use near mic (Mic 1) as L channel and far mic (Mic 2) as R channel
45°≤α<90° use near mic (Mic 1) as L channel and far mic (Mic 3) as R channel
90°≤α<135° use near mic (Mic 2) as L channel and far mic (Mic 3) as R channel
135°≤α<180° use near mic (Mic 2) as L channel and far mic (Mic 2) as R channel
−45°≤α<0° use near mic (Mic 1) as R channel and far mic (Mic 2) as L channel
−90°≤α<−45° use near mic (Mic 3) as R channel and far (Mic 2) mic as L channel
−135°≤α<−90° use near mic (Mic 3) as R channel and far mic (Mic 1) as L channel
−180°≤α<−135° use near mic (Mic 2) as R channel and far mic (Mic 1) as L channel

As shown in FIG. 10 by step 1011, in some embodiments mix and pan the selected microphone signals based on the estimated direction so that the mix and pan operations can be reversed later (with the knowledge of the estimated direction) and so that the result retains spatial characteristics better than putting selected microphone signals directly as L and R channels.

Then optionally, as shown in FIG. 10 by step 1013, adjust the equalisation of the L and R channels so that the sum of energies of L and R channels is the same as the energy of a fixed microphone. In this way the timbre of the audio signal doesn't change when different microphones are selected for different tiles.

Furthermore in some embodiments, as shown in FIG. 10 by step 1015, optionally add information about how the selected microphone audio signals can be used for audio focussing as metadata to the L&R channel audio signals.

In some embodiments the audio signals are converted back to the time domain as shown in FIG. 10 by step 1017.

Then as shown in FIG. 10 by step 1019 store/transmit direction metadata, (beamforming metadata), and the two audio signals.

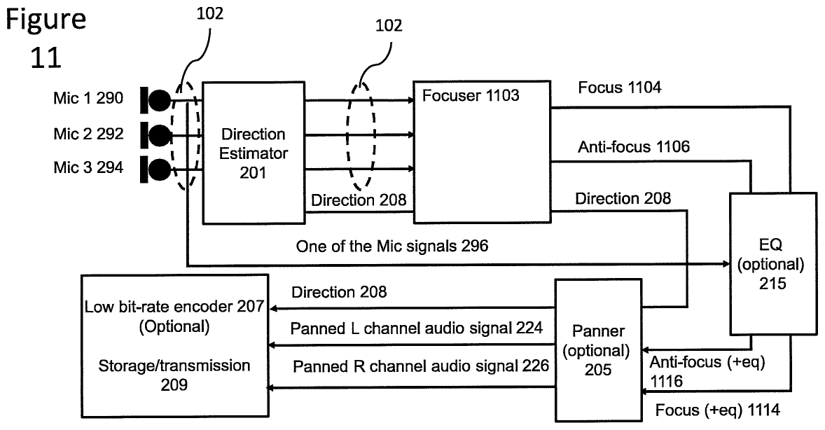

With respect to FIG. 11, there is shown the encoder side in further detail according to some embodiments where focussing based on the determined direction is implemented.

In some embodiments, as shown in FIG. 11, there is shown a series of microphones as part of the microphone array: a first microphone, mic 1, 290 a second microphone mic 2, 292, and a third microphone, mic 3, 294 which are configured to generate the audio input 102 which is passed to a direction estimator 201. Although only 3 microphones are shown in the example shown in FIG. 11 some embodiments comprise a large number (e.g. 8) microphones that are at least approximately symmetrically placed around the device.

The direction estimator 201 can be considered to be part of the metadata generation operations as described above. The direction estimator 201 thus can be configured to output the microphone audio signals in the form of the audio input 102 and the direction values 208.

The direction estimate is an estimate of the dominant sound source direction. The direction estimation as indicated above is implemented in small time frequency tiles by framing the microphone signals in typically 20 ms frames, transforming the frames into frequency domain (using DFT (Discrete Fourier Transform), DCT (Discrete Cosine Transform) or filter banks like QMF (Quadrature Mirror Filter)), splitting the frequency domain signal into frequency bands and analysing the direction in the bands. These type of framed bands of audio are referred to as time-frequency tiles. The tiles are typically narrower in low frequencies and wider in higher frequencies and may follow for example third-octave bands or Bark bands or ERB bands (Equivalent Rectangular Bandwidth). Other methods such as filterbanks exist for creating similar tiles.

In some embodiments at least one dominant sound source direction α is estimated for each tile using any suitable method such as described above.

In the embodiments described herein processing can be (and typically is) implemented in time-frequency tiles. However, for the sake of clarity the following methods are described with respect to one range of frequencies and one time instant. For example typically there would be 20-50 tiles per time instant (=frame) and the number of time instants depends on the frame length and processed audio length.

In some embodiments the encoder part comprises a focusser 1103 rather than the microphone selector 203 as shown in the examples in FIGS. 2 and 4. The focusser 1103 is configured to obtain the audio input 102 and from these audio signals generate a focus and anti-focus based on the microphone audio signals and the determined directions.

In some embodiments the focusser 1103 is configured to create two focused signals using all or any subset of the microphones. A focus signal is focused towards direction α and anti-focus signal is focused towards direction α+180°. In some embodiments a MVDR (Minimum Variance Distortionless Response) beamformer may be employed. Alternatively or additionally, other audio focus methods such as spatial filtering can be employed. In some embodiments, an anti-focus signal may be a signal that is focused to all other directions than the determined direction α. Thus in some embodiments the focusser 1103 can be configured to generate an anti-focus audio signal by subtracting the focus signal from one of the microphone signals (or a combination of the microphone audio signals).

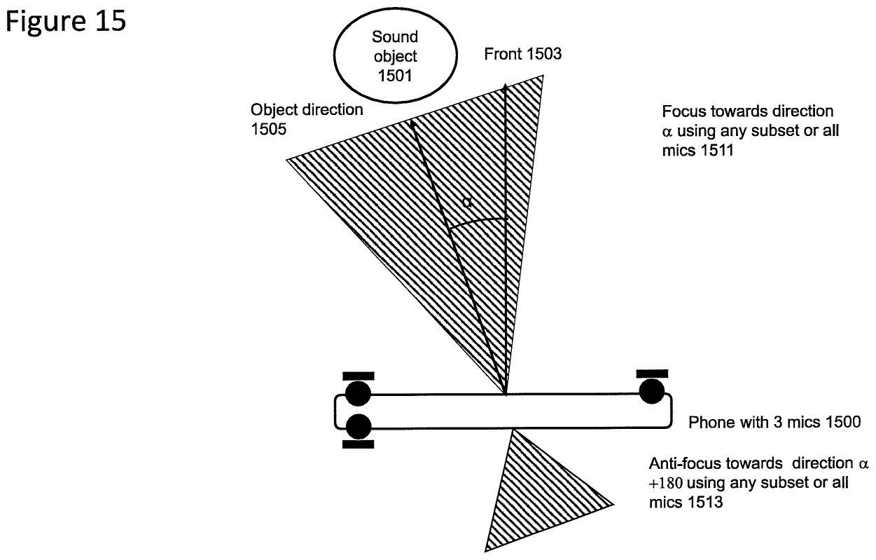

An example of the focussing is shown in FIG. 15, which shows an example apparatus, a phone with 3 microphones 1500. The phone 1500 has a defined front direction 1503 and a first front microphone (a microphone located on the front face of the apparatus), a second front microphone (another microphone located on the front face of the apparatus but near to the opposite end of the phone with respect to the first front microphone) and a back microphone (a further microphone located on the back or rear face of the apparatus and shown in this example opposite the first front microphone).

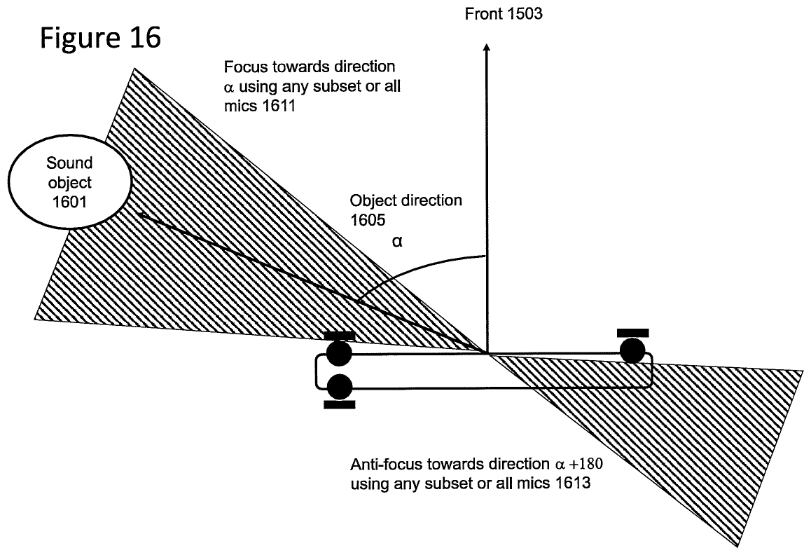

Additionally there is shown in FIG. 15 a sound object 1501 which has a direction α 1505 relative to the front axis 1503. Additionally is shown the focus 1511 towards direction using an subset of all the microphone audio signals and an anti-focus 1513 towards direction α+180 using any subset or all microphones. Additionally there is shown in FIG. 16 a sound object 1601 which has a direction α 1605 relative to the front axis 1503. Additionally is shown the focus 1611 towards direction using an subset of all the microphone audio signals and an anti-focus 1613 towards direction α+180 using any subset or all microphones.

In some embodiments the focus audio signal 1104 is used for one audio channel of the created audio signal and anti-focus audio signal 1106 used for the other channel. Furthermore in some embodiments the created audio signal is associated with metadata comprising the estimated directions and may also comprise a D/A (Direct-to-Ambient) ratio or other ratio that describes the diffuseness of the signal.

In some embodiments the focusser 1103 is configured to make one channel have the dominant sound source amplified with respect to sound sources in other directions. The direction estimation result may change continuously as the dominant sound source may move continuously (for example when there are multiple speakers around the apparatus or device and the person talking (=dominant sound source) changes continuously or when the dominant sound source moves or the apparatus or device moves.

Also as discussed previously the direction estimation of the sound sources may differ for different frequencies. Therefore, the direction from which the focus amplifies sound sources can changes continuously, the direction being the same as the estimated direction in the metadata.

In some implementations the focus and anti-focus audio signals are mapped as such as L and R channels of the output audio signal.

In some implementations the focus and anti-focus audio signals are reversibly (mixed and) panned to make the L and R signals to be more stereo (or improve the spatial effect)

For example the focus and anti-focus audio signals can in some embodiments be mapped to L and R channel audio signals so that the spatial image is partially kept:
0°≤α<180° use focus signal as L channel and anti-focus as R channel
−180°≤α<0° use focus signal as R channel and anti-focus as L channel

A constantly changing focus direction can result in a restless sounding audio signal because the perceived sound source directions and audio signal level would fluctuate. This fluctuation occurs because in practical devices the number of microphones, calibration, device shape is not symmetrical. This fluctuation can cause the focus audio signal to amplify sounds slightly differently when they come from different directions. In some embodiments, this effect can be at least partially corrected by adjusting or modifying the level of focus and antifocus audio signals to be closer to that of a typical left and right stereo signal

The encoder part furthermore in some embodiments comprises an optional equalizer 215. The equalizer 215 is configured to obtain the focus audio signal 1104, the anti-focus audio signal 1106 and furthermore one of the microphone audio signals 296.

The constant change of which microphone is used for which tile for which channel can cause annoying level changes in the L and R channel audio signals. This can in some embodiments be at least partially corrected by setting the level of L and R signals to be the same as a fixed reference microphone signal or signals. However, the setting of the L and R channel audio signals can be problematic. For example where a decoder apparatus wants to apply additional beamforming to the signals. Therefore, in some embodiments the equalizer 215 is configured to equalize the sum of L and R channel audio signals to a level of a fixed microphone signal. In implementing equalisation as described herein the original level differences between L and R channel audio signals are maintained and since beamforming is based on level (and phase) differences, the equalization does not destroy the possibility of beamforming.

Therefore, the L and R channel audio signals can be equalized so that a different gain value is applied in each tile however the gain value is the same for the corresponding tile in L and R channels. The gain values are selected so that the result sum of L and R channels (after the gain values are applied) has the same level (energy) as a reference microphone audio signal, for example microphone 1. This level correction furthermore maintains audio focus performance achieved with microphone selection. Different sound sources are acoustically mixed at different levels in the selected microphone signals so that the first microphone has sound sources in the dominant sound source direction louder in the mixture than the second microphone.

The output of the anti-focus/R channel (plus equalisation) audio signal 1116 and the focus/L channel (plus equalisation) audio signal 1114 can be passed to a panner 205.

In some embodiments the encoder part comprises (optionally) a panner 205 configured to obtain the anti-focus/R channel (plus equalisation) audio signal 1116 and the focus/L channel (plus equalisation) audio signal 1114 and the direction values 208.

The panner is configured to modify the far microphone (plus equalisation) audio signal 216 and the near microphone (plus equalisation) audio signal 214 by an invertible panning process that makes the anti-focus/R channel (plus equalisation) audio signal 1116 and the focus/L channel (plus equalisation) audio signal 1114 into a spatial audio (stereo signal) with a panned left L channel audio signal 224 and panned right R channel audio signal 226

The panning takes the selected microphone signals based on estimated direction α so that the resulting spatial (typically stereo) signal keeps the spatial audio image such that the dominant sound source is in estimated direction α at least better than without the mixing and panning and also the diffuseness of the spatial audio image is retained. The aim is to improve the quality of the spatial audio image which may be originally poor because the selected microphones are in bad positions for generating the spatial audio signal.

The panner is configured to apply a panning which is reversible with the knowledge of side information, typically the direction α because during playback, the panning may need to be reversed to get access to the original microphone signals so that user may focus elsewhere.

In some embodiments the panning is implemented in time-frequency tiles like all other processing. The processing is the same inside the tile i.e. for all frequency bins in the frequency band from a time frame that defines the tile. This is because there is only one direction estimated for all the bins inside the tile.

In some embodiments the panning can be based on a common sine panning law.

$${L}_{p a n} ( α ) = \frac{1}{2} sin ( α ) + \frac{1}{2}$$

$${R}_{p a n} ( α ) = \frac{1}{2} sin ( α + 18 {0}^{∘} ) + \frac{1}{2}$$

In some embodiments the panner is configured to pan the focus signal x_{foc} using estimated direction α and to use the anti-focus signal x_{antifoc} as a background signal that is evenly spread to both output channels L and R. Panning works because the focus audio signal comprises more of the dominant sound source from direction α than the anti-focus signal. In some embodiments reversible decorrelation filters may be used to enhance the ambience-likeness of the anti-focus signal but as a simple version just inverting the phase can be employed.

L=Lₚₐₙ(α)·x_{foc}+xₐₙₜᵢ

R=Rₚₐₙ(α)·x_{foc}−xₐₙₜᵢ

The panner 205 can then output the direction values 208, the panned left channel audio signal L 224 and the panned right channel audio signal R 226.

In some embodiments the encoder part further comprises a suitable low bit-rate encoder 207. This optionally is configured to encode the metadata and the panned left and right channel audio signals. The data may be low-bitrate encoded using codecs like mp3, AAC, IVAS etc.

Furthermore in some embodiments the encoder comprises a suitable storage/transmitter 209 configured to store and/or transmit the metadata and audio signals (which as shown herein can be encoded).

In some embodiments some beamforming parameters or other audio focus parameters may be generated and transmitted as metadata. These can be used during playback to focus audio towards dominant and opposite directions. For example a MVDR (Minimum Variance Distortionless Response) beamformer may be employed. The parameters may be transmitted once for all microphone pairs and focus directions or they may be transmitted in real time when a listener (user) initiates audio focus during playback. The beamforming parameters are typically phases and gains that are multiplied with the signals before summing them to achieve beamforming.

In some embodiments the beamforming parameters comprise a delay (phase) that describes the distance between the two selected microphones. It is understood that generating and transmitting beamforming parameters is not absolutely necessary, because the near microphone signal is already naturally (because of acoustic shadowing from the device) emphasizing the dominant sound source and the far microphone de-emphasizes the dominant sound source.

It would be understood that the encoder as described with respect to FIG. 11 shows elements which are pertinent to the understanding of the embodiments. Typically, an encoding or capture apparatus would be configured to employ other audio processing such as microphone equalization, gain compensation, noise cancellation, dynamic range compression analogue-to-digital transformation (and vice versa) etc.

Additionally in the embodiments described herein the focus is described as a 2D focus only on horizontal plane. However in some embodiments a 3D focus can be implemented where the microphones are not only on a horizontal plane and the apparatus is configured to select two microphones that aren't on a horizontal plane or focus towards directions outside horizontal plane. Typically, this would require an apparatus to comprise at least four microphones.

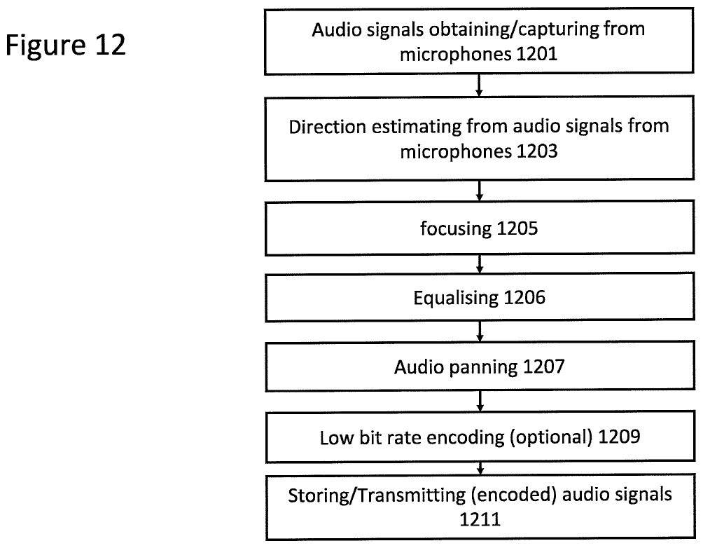

Thus with respect to FIG. 12 is shown a flow diagram of the operations which are implemented by the encoder part as shown in FIG. 11.

For example the operations comprise that of audio signals obtaining/capturing from microphones as shown in FIG. 12 by step 1201.

Then the following operation is one of direction estimating from audio signals from microphones as shown in FIG. 12 by step 1203.

The following operation is one of generating the focus and anti-focus audio signals (based on the dominant sound source direction) as shown in FIG. 12 by step 1205.

Then there is an optional operation of equalising the selected audio signals as shown in FIG. 12 by step 1206.

Following on there can be an audio panning applied to the selected (and equalised) audio signals as shown in FIG. 12 by step 1207.

There can be furthermore comprise an operation of low bit rate encoding which is optional as shown in FIG. 12 by step 1209.

Finally with respect to the encoder side there is shown an operation of storing/transmitting (encoded) audio signals as shown in FIG. 12 by step 1211.

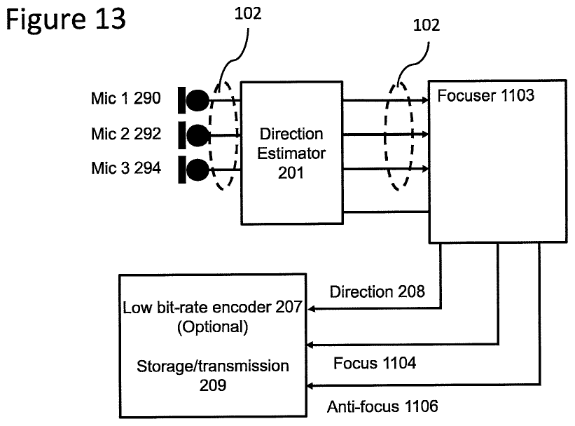

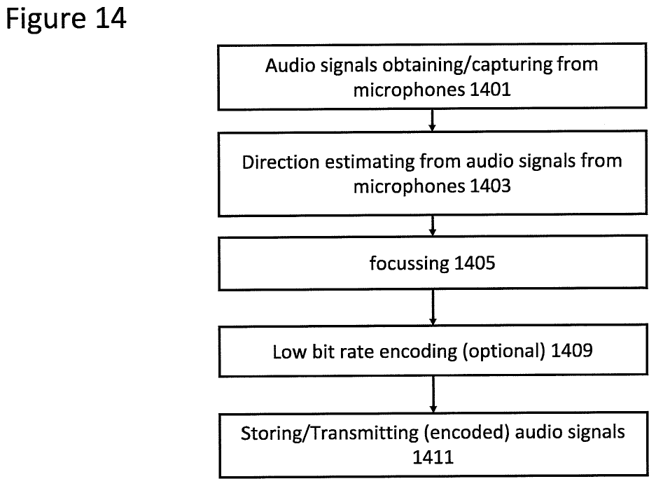

Furthermore is shown with respect to FIGS. 13 and 14 a ‘bare bones’ encoder part and the operations associated with the ‘bare bones’ encoder respectively.

Thus FIG. 13 shows the direction estimator 201, focusser 1103 and encoder (optional) 207 and storage/transmitter 209 as described above and FIG. 14 shows the operations of obtaining/capturing from microphones (step 1401), direction estimating from audio signals from microphones (step 1403), focussing (step 1405), low bit rate encoding (optional step 1409) and storing/transmitting (encoded) audio signals (step 1411).

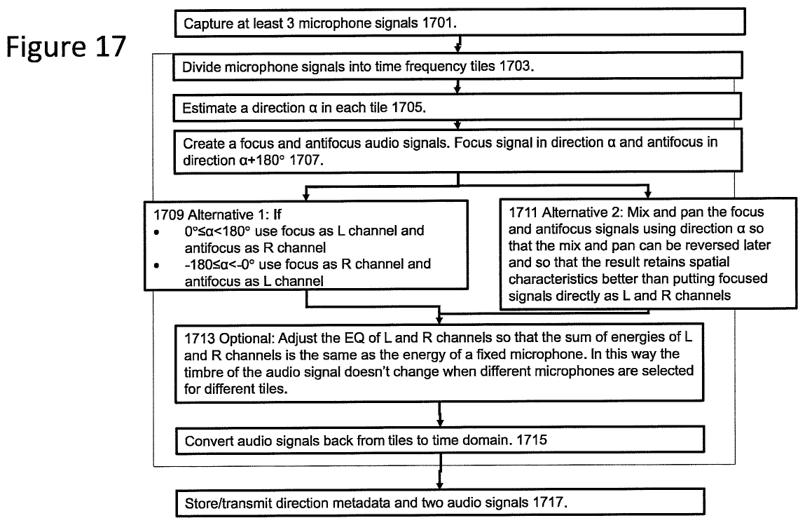

Furthermore with respect to FIG. 17 is shown in further detail an example set of operations employed by the apparatus according to some embodiments.

The first operation is to capture at least 3 microphone signals as shown in FIG. 17 by step 1701.

Then, having captured at least 3 microphone signals, divide the microphone signals into time frequency tiles as shown in FIG. 17 by step 1703.

Following this estimate a direction α in each tile as shown in FIG. 17 by step 1705.

Create a focus and antifocus audio signals. Focus signal in direction α and antifocus in direction α+180° as shown in FIG. 17 by step 1707.

In some embodiments the following mapping as shown in FIG. 17 by step 1709 can be implemented:

### If

0°≤α<180° use focus audio signal as L channel audio signal and anti-focus audio signal as R channel audio signal
−180≤α<−0° use focus audio signal as R channel audio signal and anti-focus audio signal as L channel audio signal

As shown in FIG. 17 by step 1711, in some embodiments mix and pan the focus and anti-focus audio signals based on the estimated direction so that the mix and pan operations can be reversed later (with the knowledge of the estimated direction) and so that the result retains spatial characteristics better than putting selected microphone signals directly as L and R channels.

Then optionally, as shown in FIG. 17 by step 1713, adjust the equalisation of the L and R channels so that the sum of energies of L and R channels is the same as the energy of a fixed microphone. In this way the timbre of the audio signal doesn't change when different microphones are selected for different tiles.

Furthermore in some embodiments, as shown in FIG. 17 by step 1715, optionally add information about how the selected microphone audio signals can be used for audio focussing as metadata to the L&R channel audio signals.

In some embodiments the audio signals are converted back to the time domain as shown in FIG. 17 by step 1717.

Then as shown in FIG. 17 by step 1719 store/transmit direction metadata, (beamforming metadata), and the two audio signals.

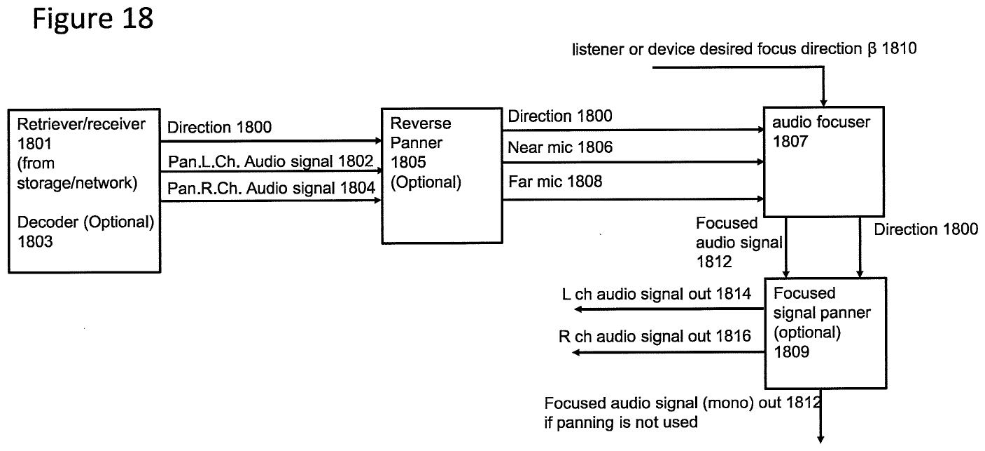

With respect to FIG. 18 is shown an example decoder part in further detail. In some embodiments the example decoder part is the same apparatus or device as shown with respect to the encoder part shown in FIG. 2 or 4 or may be a separate apparatus or device.

The decoder part for example can in some embodiments comprise a retriever/receiver 1801 configured to retrieve or receive the ‘stereo’ audio signals and the metadata including the direction values from the storage or from the network. The retriever/receiver is thus configured be the reciprocal to the storage/transmission 209 as shown in FIG. 2.

Furthermore in some embodiments the decoder part comprises a decoder 1803, which is optional, which is configured to apply a suitable inverse operation to the encoder 207.

The direction 1800 values and the panned left channel audio signal L 1802 and the panned right channel audio signal R 1804 can then be passed to the reverse panner 1805 (or directly to the audio focusser 1807).

In some embodiments the decoder part comprises an optional reverse panner 1805. The reverse panner 1805 is configured to receive the direction values 1800 and the panned left channel audio signal L 1802 and the panned right channel audio signal R 1804 and regenerate the near microphone audio signal xₙₑₐᵣ 1806, the far microphone audio signal x_{far} 1808 and the direction 1800 values and pass these to the audio focusser 1807.

With help of the direction metadata the reverse panner 1805 is configured to reverse the panning process (applied in the encoder part) and thus ‘access’ the original selected microphone signals:

$${x}_{n e a r} = \frac{L + R}{{L}_{ρ a n} ( α ) + {R}_{pan} ( α )}$$

$${x}_{f a r} = L - {L}_{p α n} ( α ) \frac{L + R}{{L}_{p a n} ( α ) + {R}_{ρ a n} ( α )}$$

The decoder part further can comprise in some embodiments an audio focusser 1807 configured to obtain the near microphone audio signal 1806, the far microphone audio signal 1808 and the direction 1800 values. Additionally the audio focusser is configured to receive the listener or device desired focus direction β 1810. The audio focusser 1810 is thus configured to (with the reverse panner 1805) to focus the L and R spatial audio signals towards a direction β by reversing the panning process (and generating the near and far microphone audio signals and then generating the focussed audio signal 1812 and the direction value 1800.

The audio focus can thus be achieved using the xₙₑₐᵣ and x_{far} signals. The xₙₑₐᵣ signal emphasizes the dominant sound source in direction α and x_{far} emphasizes the opposite direction. If a listener or user wants to focus towards the dominant sound source direction (i.e. α=β) then in some embodiments the xₙₑₐᵣ signal is amplified with respect to the x_{far} signal in the output. If a listener or user wants to focus away from the dominant sound source direction (i.e. α=β+180°) then in some embodiments the x_{far} signal is amplified with respect to the xₙₑₐᵣ signal in the output.

The same can be implemented in some embodiments where the listener or user wants to focus near the dominant signal direction or near the opposite direction, because focusing is typically not very accurate and as a coarse example for one focusing method, beamforming might amplify sound sources in a 40° wide sector with a 3 microphone device instead of just amplifying sound sources in an exact direction. Thus if the listener or user wants to focus clearly towards other directions, neither signal is amplified in the output or the opposite direction is amplified somewhat more that the dominant sound source direction. Although it may be thought that this audio focus approach is not very accurate, if the user desired focus direction is not the same as the dominant sound source direction, then even when best focus methods and all data is available, the best result is that the dominant sound source is somewhat attenuated.

Furthermore as the reverse panner 1805 is configured to generate xₙₑₐᵣ and x_{far} in some embodiments it is also possible to employ beamforming, where beamforming parameters were transmitted in the metadata. In some embodiments beamforming is implemented using any suitable methods based on the parameters.

Beamforming can in some embodiments be implemented towards directions α and α+180°. In this way the beamformer is configured to create a mono focused signal in direction α and mono antifocused signal in direction α+180°. For sake of clarity, in this embodiment the focused signal is called xₙₑₐᵣ and the antifocused signal is called x_{far} as if nothing had happened since this beamforming step is optional in this embodiment.

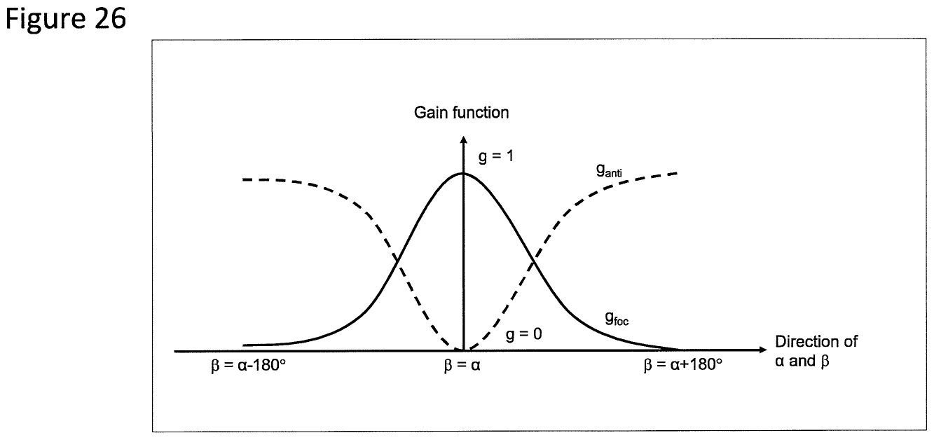

Based on user input direction, the audio focused signal towards the user input direction β is implemented by summing the xₙₑₐᵣ and x_{far} signals with suitable gains. The gains depend on the difference of the directions α and β. An example function for the gains is shown in FIG. 26

focused signal=x_{focus}=gₙₑₐᵣ·xₙₑₐᵣ+g_{far}*x_{far}

In such embodiments the audio focusser is configured to use mostly xₙₑₐᵣ when user desired direction is the same as the dominant sound direction and to use mostly x_{far} when user desired direction is opposite to the dominant sound direction. For other directions, the xₙₑₐᵣ and x_{far} are mixed more evenly.

The x_{focus} can be used as such if a mono focused signal is enough.

In some embodiments the mono focussed audio signal can also be mixed with the received L and R signals at different levels if different levels of audio focus (e.g. a little focus, medium focus, strong focus or full focus) are desired.

In some embodiments the decoder part comprises a focussed signal panner 1809 configured to spatialize the x_{focus} signal 1812 by panning the audio signal to direction α.

For example the focussed signal panner 1809 can be configured to apply the following where g_{zoom} is a gain between 0 and 1 where 1 indicates fully focused and 0 indicates no focus at all. For better quality spatial audio the zoom could be limited e.q. to be at max 0.5. This would keep the audio signal spatial characteristics better.

Lₒᵤₜ=g_{zoom}·Lₚₐₙ(α)·x_{focus}+(1−g_{zoom})L

Rₒᵤₜ=g_{zoom}·Rₚₐₙ(α)·x_{focus}+(1−g_{zoom})R

A more complex panning for the x_{focus} could take diffuseness into account. Diffuseness is estimated using known methods and typically expressed as D/A ratio (Direct-to-Ambient). If diffuseness is low (D/A ratio=1), then x_{focus} is panned as in the equation above. If diffuseness is high (D/A ratio=0), then the x_{focus} typically contains also a lot of other sound sources than the dominant sound source or there is no clear dominant sound source and in this case the focus signal should be panned to all directions equally. This can be achieved with the following:

$${L}_{o u t} = {g}_{z o o m} \cdot ( {DA}_{r a t i o} \cdot {L}_{ρ a n} ( α ) + \frac{1}{2} \cdot ( 1 - {DA}_{ratio} ) ) \cdot {x}_{focus} + ( 1 - {g}_{z o o m} ) L$$

$${R}_{o u t} = {g}_{z o o m} \cdot ( {DA}_{r a t i o} \cdot {R}_{ρ a n} ( α ) + \frac{1}{2} \cdot ( 1 - {DA}_{r a t i o} ) ) \cdot {x}_{f o c u s} + ( 1 - {g}_{z o ∘ m} ) R$$

As described above the processing can be performed in the time-frequency domain where parameters may differ from time-frequency tile to tile. Additionally in some embodiments the time-frequency domain audio signal(s) is converted back to the time domain and played/stored.

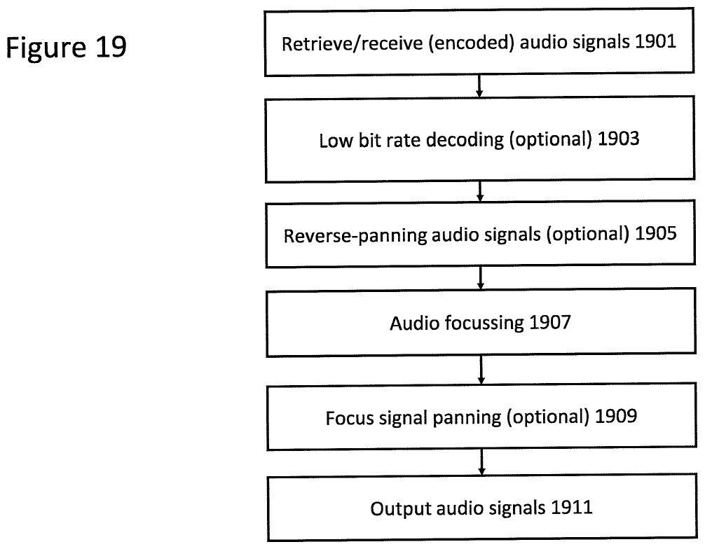

With respect to FIG. 19 is shown an example flow diagram of the operations implemented by the embodiments shown with respect to FIG. 18.

Thus the initial operation is one of retrieve/receive (encoded) audio signals as shown in FIG. 19 by step 1901.

Optionally the audio signals can then be low bit rate decoded as shown in FIG. 19 by step 1903.

Additionally in some embodiments there is the further optional operation of reverse-panning the audio signals as shown in FIG. 19 by step 1905.

The channel or reverse-panned audio signals are then audio focussed based on the listener or device direction as shown in FIG. 19 by step 1907.

The focus signal is then optionally panned as shown in FIG. 19 by step 1909.

Then the output audio signals are output as shown in FIG. 19 by step 1911.

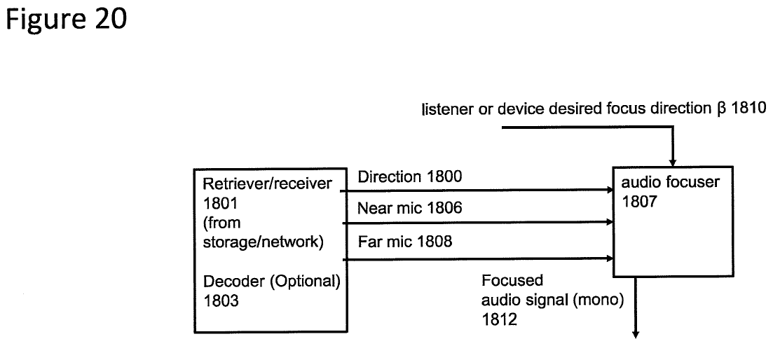

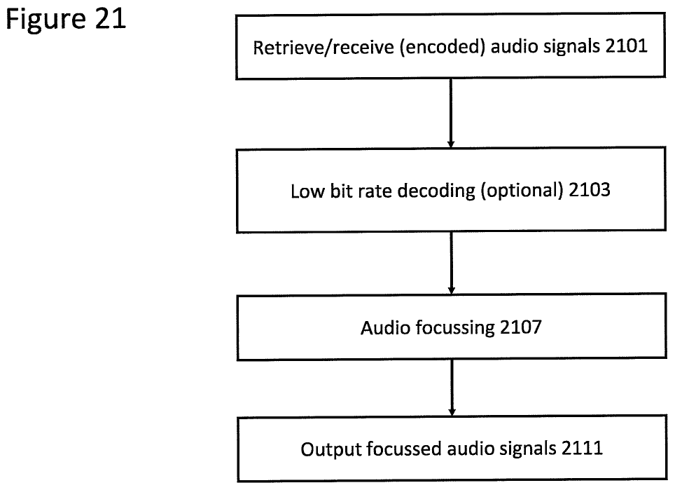

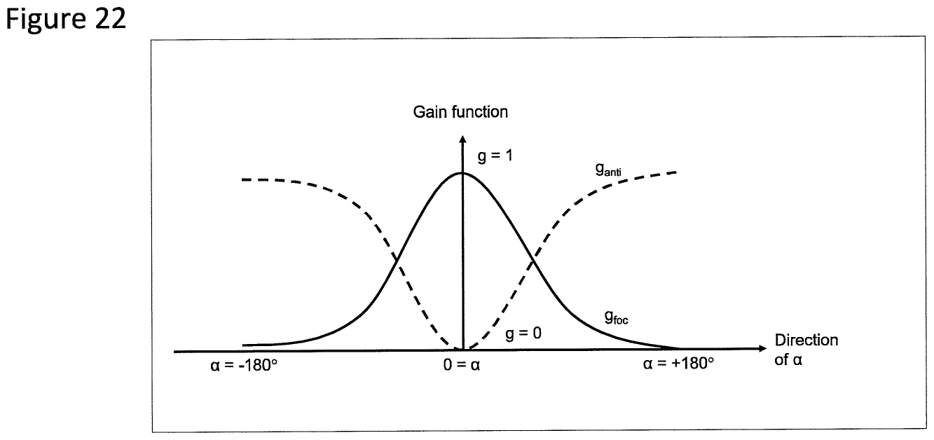

With respect to FIGS. 20 and 21 are shown a ‘bare bones’ based decoder based on the decoder shown in FIG. 18. In this example the decoder comprises the retriever/receiver 1801, the optional decoder 1803 and the audio focuser 1807. The operations comprise the method steps of retrieve/receive (encoded) audio signals (step 2101), low bit rate decoding (step 2103), Audio focussing (step 2107) and output focussed audio signals (step 2111).

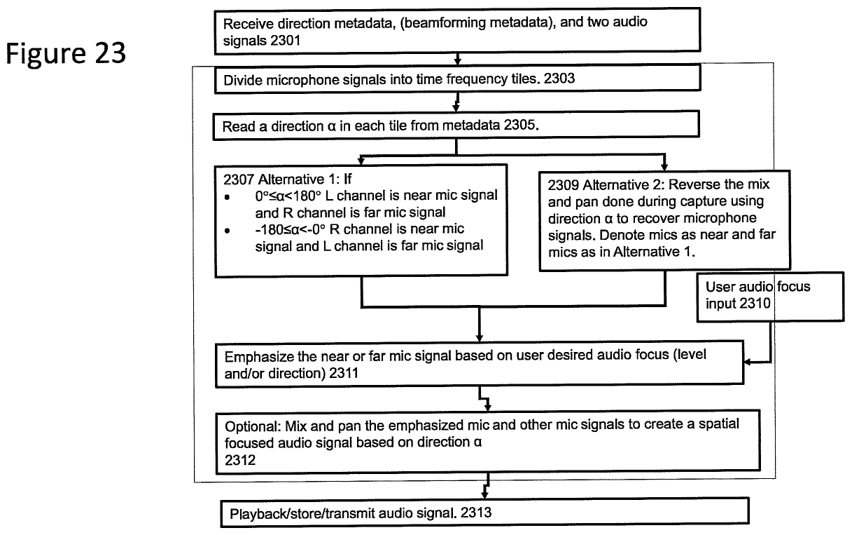

FIG. 23 furthermore shows in further detail an example decoding according to some embodiments.

Receive direction metadata, (beamforming metadata), and two audio signals as shown in FIG. 23 step 2301.

Divide microphone signals into time frequency tiles as shown in FIG. 23 by step 2303.

Read a direction α in each tile from metadata as shown in FIG. 23 by step 2305.

As shown in FIG. 23 step 2307, there is the option of if:
0°≤α<180° L channel is near mic signal and R channel is far mic signal
−180≤α<−0° R channel is near mic signal and L channel is far mic signal

Also is shown in FIG. 23 step 2309 the option of reverse the mix and pan done during capture using direction α to recover microphone signals. Denote mics as near and far mics in a manner as shown in step 2307.

Receive the user audio focus input as shown in FIG. 23 by step 2310.

Emphasize the near or far mic signal based on user desired audio focus (level and/or direction) as shown in FIG. 23 step 2311.

Then optionally mix and pan the emphasized mic and other mic signals to create a spatial focused audio signal based on direction α as shown in FIG. 23 step 2312.

Finally playback/store/transmit audio signal as shown in FIG. 23 by step 2313.

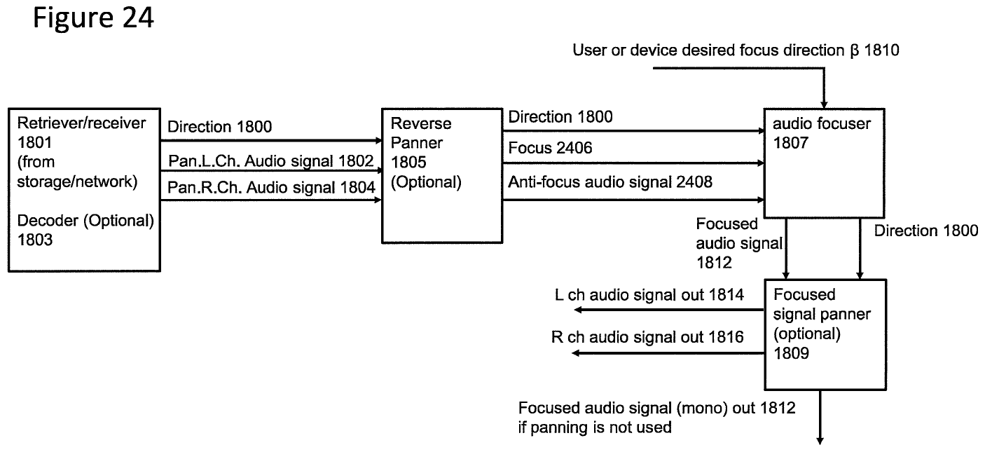

With respect to FIG. 24 is shown an example decoder part in further detail. In some embodiments the example decoder part is the same apparatus or device as shown with respect to the encoder part shown in FIG. 11 or 13 or may be a separate apparatus or device.

The decoder part for example can in some embodiments comprise a retriever/receiver 1801 configured to retrieve or receive the ‘stereo’ audio signals and the metadata including the direction values from the storage or from the network. The retriever/receiver is thus configured be the reciprocal to the storage/transmission 1109 as shown in FIG. 11.

Furthermore in some embodiments the decoder part comprises a decoder 1803, which is optional, which is configured to apply a suitable inverse operation to the encoder 1107.

The direction 1800 values and the panned left channel audio signal L 1802 and the panned right channel audio signal R 1804 can then be passed to the reverse panner 1805 (or directly to the audio focusser 1807).

In some embodiments the decoder part comprises an optional reverse panner 1805. The reverse panner 1805 is configured to receive the direction values 1800 and the panned left channel audio signal L 1802 and the panned right channel audio signal R 1804 and regenerate the focus audio signal x_{foc} 2406, the anti-focus microphone audio signal x_{antifoc} 2408 and the direction 1800 values and pass these to the audio focusser 1807.

With help of the direction metadata the reverse panner 1805 is configured to reverse the panning process (applied in the encoder part) and thus ‘access’ the original selected microphone signals:

$${x}_{f o c} = \frac{L + R}{{L}_{p a n} ( α ) + {R}_{pan} ( α )}$$

$${x}_{anti} = L - {L}_{p a n} \frac{L + R}{{L}_{ρ an} ( a ) + {R}_{ρ a n} ( α )}$$

The decoder part further can comprise in some embodiments an audio focusser 1807 configured to obtain the focus audio signal x_{foc} 2406, the anti-focus microphone audio signal x_{antifoc} 2408 and the direction 1800 values. Additionally the audio focusser is configured to receive the listener or device desired focus direction β 1810. The audio focusser 1807 is thus configured to (with the reverse panner 1805) to focus the L and R spatial audio signals towards a direction β by reversing the panning process (and generating the near and far microphone audio signals and then generating the focussed audio signal 1812 and the direction value 1800.

The audio focus can thus be achieved using the focus audio signal x_{foc} 2406 and the anti-focus microphone audio signal x_{antifoc} 2408. The focus audio signal x_{foc} 2406 signal emphasizes the dominant sound source in direction α and the anti-focus microphone audio signal x_{antifoc} 2408 emphasizes the opposite direction. If a listener or user wants to focus towards the dominant sound source direction (i.e. α=β) then in some embodiments the x_{foc} signal is amplified with respect to the x_{antifoc} signal in the output. If a listener or user wants to focus away from the dominant sound source direction (i.e. α=β+180°) then in some embodiments the x_{antifoc} signal is amplified with respect to the x_{foc} signal in the output.

The same can be implemented in some embodiments where the listener or user wants to focus near the dominant signal direction or near the opposite direction, because focusing is typically not very accurate and as a coarse example for one focusing method, beamforming might amplify sound sources in a 40° wide sector with a 3 microphone device instead of just amplifying sound sources in an exact direction. Thus if the listener or user wants to focus clearly towards other directions, neither signal is amplified in the output or the opposite direction is amplified somewhat more that the dominant sound source direction. Although it may be thought that this audio focus approach is not very accurate, if the user desired focus direction is not the same as the dominant sound source direction, then even when best focus methods and all data is available, the best result is that the dominant sound source is somewhat attenuated.

Based on user input direction, the audio focused signal towards the user input direction β is implemented by summing the x_{foc} and x_{antifoc} signals with suitable gains. The gains depend on the difference of the directions α and β. An example function for the gains is shown in FIG. 26

focused signal=x_{focus}=gₙₑₐᵣ·xₙₑₐᵣ+g_{far}·x_{far}

In such embodiments the audio focusser is configured to use mostly x_{foc} when user desired direction is the same as dominant sound direction and to use mostly xₐₙₜᵢ when user desired direction is opposite to the dominant sound direction. For other directions, the x_{foc} and xₐₙₜᵢ are mixed more evenly.

The x_{focus} can be used as such if a mono focused signal is enough. It can also be mixed with the received L and R signals at different levels if different levels of audio focus (a little focus, medium focus, strong focus or focus 0 . . . 1, etc) are desired. The x_{focus} signal can also be spatialized by panning to direction α. The following equation has g_{zoom} as a gain between 0 and 1 where 1 indicates fully zoomed and 0 indicates no zoom at all. For better quality spatial audio the zoom could be limited e.q. to be at max 0.5. This would keep the audio signal spatial characteristics better.

Lₒᵤₜ=g_{zoom}·Lₚₐₙ(α)·x_{focus}+(1−g_{zoom})L

Rₒᵤₜ=g_{zoom}·Rₚₐₙ(α)·x_{focus}+(1−g_{zoom})R

A more complex panning for the x_{focus} could take diffuseness into account. Diffuseness is estimated using known methods and typically expressed as D/A ratio (Direct-to-Ambient). If diffuseness is low (D/A ratio=1), then x_{focus} is panned as in the equation above. If diffuseness is high (D/A ratio=0), then the x_{focus} typically contains also a lot of other sound sources than the dominant sound source or there is no clear dominant sound source and in this case the focus signal should be panned to all directions equally. This can be achieved with the following:

$${L}_{o u t} = {g}_{z o o m} \cdot ( {DA}_{r a t i o} \cdot {L}_{p a n} ( a ) + \frac{1}{2} \cdot ( 1 - {DA}_{r a t i o} ) ) \cdot {x}_{focus} + ( 1 - {g}_{zoom} ) L$$

$${R}_{o u t} = {g}_{z o o m} \cdot ( {DA}_{r a t i o} \cdot {R}_{pan} ( α ) + \frac{1}{2} \cdot ( 1 - {DA}_{ratio} ) ) \cdot {x}_{f o c u s} + ( 1 - {g}_{z o o m} ) R$$

As described above the processing can be performed in the time-frequency domain where parameters may differ from time-frequency tile to tile. Additionally in some embodiments the time-frequency domain audio signal(s) is converted back to the time domain and played/stored.

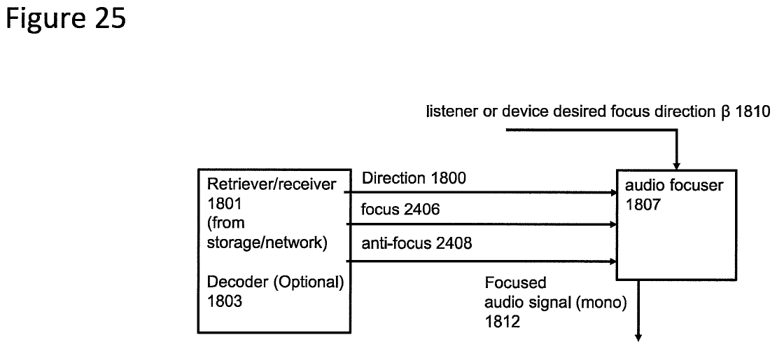

With respect to FIG. 25 is shown a ‘bare bones’ based decoder based on the decoder shown in FIG. 24. In this example the decoder comprises the retriever/receiver 1801, the optional decoder 1803 and the audio focuser 1807.

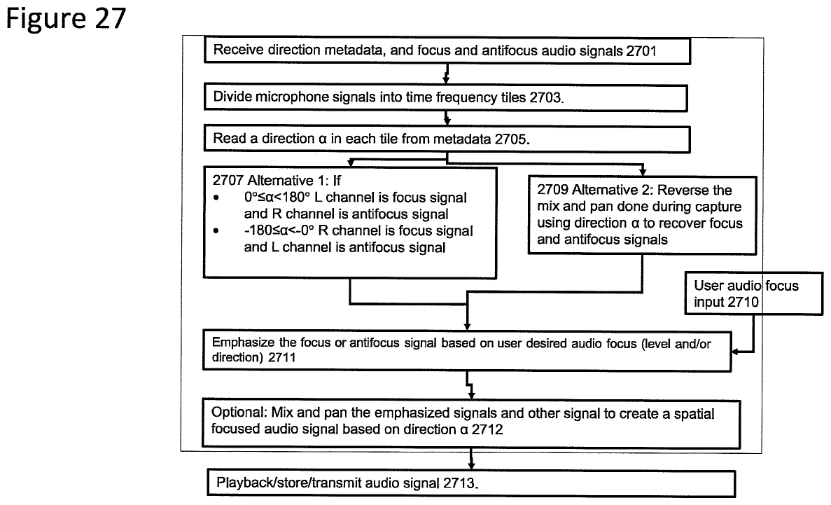

FIG. 27 furthermore shows in further detail an example decoding according to some embodiments.

Receive direction metadata, (beamforming metadata), and two audio signals as shown in FIG. 27 step 2701.

Divide microphone signals into time frequency tiles as shown in FIG. 27 by step 2703.

Read a direction α in each tile from metadata as shown in FIG. 27 by step 2705.

As shown in FIG. 27 step 2707, there is the option of if:
0°≤α<180° L channel is focus audio signal and R channel is anti-focus audio signal
−180≤α<−0° R channel is focus audio signal and L channel is anti-focus signal

Also is shown in FIG. 27 step 2309 the option of reverse the mix and pan done during capture using direction α to recover focus and anti-focus audio signals.

Receive the user audio focus input as shown in FIG. 27 by step 2710.

Emphasize the focus and anti-focus audio signal based on user desired audio focus (level and/or direction) as shown in FIG. 27 step 2711.

Then optionally mix and pan the emphasized mic and other mic signals to create a spatial focused audio signal based on direction α as shown in FIG. 27 step 2712.

Finally playback/store/transmit audio signal as shown in FIG. 27 by step 2713.

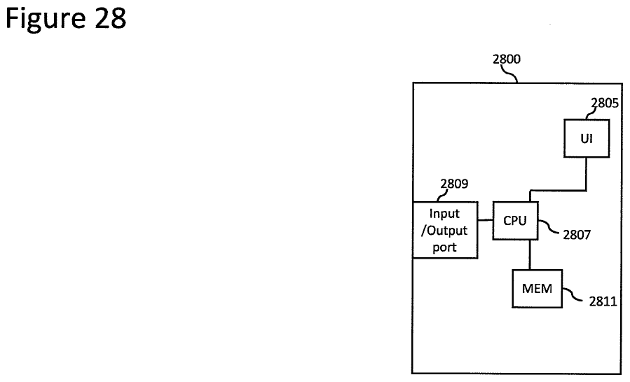

With respect to FIG. 28 an example electronic device which may be used as any of the apparatus parts of the system as described above. The device may be any suitable electronics device or apparatus. For example, in some embodiments the device 2800 is a mobile device, user equipment, tablet computer, computer, audio playback apparatus, etc. The device may for example be configured to implement the encoder/analyser part and/or the decoder part as shown in FIG. 1 or any functional block as described above.

In some embodiments the device 2800 comprises at least one processor or central processing unit 2807. The processor 2807 can be configured to execute various program codes such as the methods such as described herein.

In some embodiments the device 2800 comprises at least one memory 2811. In some embodiments the at least one processor 2807 is coupled to the memory 2811. The memory 2811 can be any suitable storage means. In some embodiments the memory 2811 comprises a program code section for storing program codes implementable upon the processor 2807. Furthermore, in some embodiments the memory 2811 can further comprise a stored data section for storing data, for example data that has been processed or to be processed in accordance with the embodiments as described herein. The implemented program code stored within the program code section and the data stored within the stored data section can be retrieved by the processor 2807 whenever needed via the memory-processor coupling.

In some embodiments the device 2800 comprises a user interface 2805. The user interface 2805 can be coupled in some embodiments to the processor 2807. In some embodiments the processor 2807 can control the operation of the user interface 2805 and receive inputs from the user interface 2805. In some embodiments the user interface 2805 can enable a user to input commands to the device 2800, for example via a keypad. In some embodiments the user interface 2805 can enable the user to obtain information from the device 2800. For example the user interface 2805 may comprise a display configured to display information from the device 2800 to the user. The user interface 2805 can in some embodiments comprise a touch screen or touch interface capable of both enabling information to be entered to the device 2800 and further displaying information to the user of the device 2800. In some embodiments the user interface 2805 may be the user interface for communicating.

In some embodiments the device 2800 comprises an input/output port 2809. The input/output port 2809 in some embodiments comprises a transceiver. The transceiver in such embodiments can be coupled to the processor 2807 and configured to enable a communication with other apparatus or electronic devices, for example via a wireless communications network. The transceiver or any suitable transceiver or transmitter and/or receiver means can in some embodiments be configured to communicate with other electronic devices or apparatus via a wire or wired coupling.

The transceiver can communicate with further apparatus by any suitable known communications protocol. For example in some embodiments the transceiver can use a suitable radio access architecture based on long term evolution advanced (LTE Advanced, LTE-A) or new radio (NR) (or can be referred to as 5G), universal mobile telecommunications system (UMTS) radio access network (UTRAN or E-UTRAN), long term evolution (LTE, the same as E-UTRA), 2G networks (legacy network technology), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs), cellular internet of things (IoT) RAN and Internet Protocol multimedia subsystems (IMS), any other suitable option and/or any combination thereof.

The transceiver input/output port 2809 may be configured to receive the signals.

In some embodiments the device 2800 may be employed as at least part of the synthesis device. The input/output port 2809 may be coupled to headphones (which may be a headtracked or a non-tracked headphones) or similar and loudspeakers.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general-purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. A method for generating spatial audio signals, the method comprising:
obtaining at least three microphone audio signals, wherein the microphone audio signals are associated with microphones with a location relative to an apparatus on which the microphones are located;
analysing the at least three microphone audio signals to determine at least one metadata directional parameter;
generating a first audio signal and a second audio signal based on at least one of the at least three microphone audio signals or the at least one metadata directional parameter; and
at least one of outputting or storing the first audio signal, the second audio signal, and the at least one metadata directional parameter, such that the first audio signal, the second audio signal, and the at least one metadata directional parameter enable a generation of an output audio signal with an adjustable audio focusing.

2. The method as claimed in claim 1, wherein generating the first audio signal and the second audio signal based on at least one of the at least three microphone audio signals and the at least one metadata directional parameter comprises:
selecting a first of the at least three microphone audio signals to generate the first audio signal, the selected first of the at least three microphone audio signals with a location relative to the apparatus closest to the at least one metadata directional parameter; and
selecting a second of the at least three microphone audio signals to generate the second audio signal, the selected second of the at least three microphone audio signals with a location relative to the apparatus furthest from the at least one metadata directional parameter.

3. The method as claimed in claim 1, wherein generating the first audio signal and the second audio signal based on at least one of the at least three microphone audio signals and the at least one metadata directional parameter comprises:
generating the first audio signal from a mix of the at least three microphone audio signals, the mix of the at least three microphone audio signals having a focus direction closest to the at least one metadata directional parameter; and
generating the first audio signal from a second mix of the at least three microphone audio signals, the second mix of the at least three microphone audio signals having a focus direction furthest from the at least one metadata directional parameter.

4. The method as claimed in claim 2, wherein generating the first audio signal comprises generating the first audio signal as an additive combination of the second mix of the at least three microphone audio signals and a panning of the mix of the at least three microphone audio signals to a left channel direction based on the at least one metadata directional parameter.

5. The method as claimed in claim 4, wherein generating the second output audio signal comprises generating the second output audio signal as a subtractive combination of the second mix of the at least three microphone audio signals and a panning of the mix of the at least three microphone audio signals to a right channel direction based on the at least one metadata directional parameter.

6. A method for processing spatial audio signals, the method comprising:
obtaining a first audio signal, a second audio signal, and at least one metadata directional parameter;
obtaining a desired focus directional parameter;
generating a focus audio signal towards the desired focus directional parameter value, the focus audio signal based on the desired focus directional parameter, the at least one metadata directional parameter, the first audio signal, and the second audio signal; and
generating at least one output audio signal based on the focus audio signal.

7. The method as claimed in claim 6, wherein prior to generating the focus audio signal the method comprises:
de-panning the first audio signal; and
de-panning the second audio signal, wherein generating the focus audio signal comprises generating the focus audio signal based on a combination of the de-panned first audio signal and the de-panned second audio.

8. The method as claimed in claim 6, wherein generating at least one output audio signal based on the focus audio signal comprises:
generating a first output audio signal based on a combination of the focus audio signal and the first audio signal; and
generating a second output audio signal based on a combination of the focus audio signal and the second audio signal.

9. The method as claimed in claim 6, wherein generating a focus audio signal towards the desired focus directional parameter value, the focus audio signal based on the desired focus directional parameter, the at least one metadata directional parameter, the first audio signal and the second audio signal comprises:
where the difference between the at least one metadata directional parameter value and the desired focus directional parameter value is less than a threshold value, the focus audio signal is a selection of one of the first audio signal or the second audio signal;
where the difference between the at least one metadata directional parameter value and the desired focus directional parameter value is greater than a further threshold value, the focus audio signal is a selection of the other of the first audio signal or the second audio signal; and
where the difference between the at least one metadata directional parameter value and the desired focus directional parameter value is less than the further threshold value and more than the threshold value, the focus audio signal is a mix of the first audio signal or the second audio signal.

10. An apparatus, comprising:
at least one processor; and
at least one non-transitory memory storing instructions that, when executed with the at least one processor, cause the apparatus at least to:
obtain at least three microphone audio signals, wherein the microphone audio signals are associated with microphones with a location relative to the apparatus on which the microphones are located;
analyse the at least three microphone audio signals to determine at least one metadata directional parameter;
generate a first audio signal and a second audio signal based on at least one of the at least three microphone audio signals or the at least one metadata directional parameter; and
at least one of output or store the first audio signal, the second audio signal and the at least one metadata directional parameter, such that the first audio signal, the second audio signal, and the at least one metadata directional parameter enable a generation of an output audio signal with an adjustable audio focusing.

11. (canceled)

12. The apparatus as claimed in claim 10, wherein the instructions, when executed with the at least one processor, cause the apparatus to generate the first audio signal and the second audio signal based on:
selecting a first of the at least three microphone audio signals to generate the first audio signal, the selected first of the at least three microphone audio signals with a location relative to the apparatus closest to the at least one metadata directional parameter; and
selecting a second of the at least three microphone audio signals to generate the second audio signal, the selected second of the at least three microphone audio signals with a location relative to the apparatus furthest from the at least one metadata directional parameter.

13-14. (canceled)

15. An apparatus comprising:
at least one processor; and
at least one non-transitory memory storing instructions that, when executed with the at least one processor, cause the apparatus at least to:
obtain a first audio signal, a second audio signal, and at least one metadata directional parameter;
obtain a desired focus directional parameter;
generate a focus audio signal towards the desired focus directional parameter value, the focus audio signal based on the desired focus directional parameter, the at least one metadata directional parameter, the first audio signal, and the second audio signal; and
generate at least one output audio signal based on the focus audio signal.

16. The method as claimed in claim 1, wherein obtaining at least three microphone audio signals comprises capturing audio using at least three microphones and the method further comprises:
determining a dominant sound source direction using said captured audio signals;
selecting two microphones that are closest to a line from the apparatus towards the dominant sound source direction;
creating an audio signal using the selected two microphones and the at least one metadata directional parameter; and
at least one of transmitting or storing the created audio signal.

17. The method as claimed in claim 1, further comprising:
detecting a dominant sound source direction in time-frequency tiles of the at least three microphone audio signals;
creating two audio signals, a first audio signal that is focused towards the dominant sound source direction in the tile and a second audio signal that is focused away from the dominant sound source direction in the tile;
creating a parametric spatial audio signal using the focused two audio signals and the at least one metadata directional parameter; and
at least one of transmitting or storing the parametric spatial audio signal.

18. The apparatus as claimed in claim 12, wherein the instructions, when executed with the at least one processor, cause the apparatus to:
generate the first audio signal from a mix of the at least three microphone audio signals, the mix of the at least three microphone audio signals having a focus direction closest to the at least one metadata directional parameter; and
generate the first audio signal from a second mix of the at least three microphone audio signals, the second mix of the at least three microphone audio signals having a focus direction furthest from the at least one metadata directional parameter.

19. The apparatus as claimed in claim 18, wherein the instructions, when executed with the at least one processor, cause the apparatus to generate the first audio signal as an additive combination of the second mix of the at least three microphone audio signals and a panning of the mix of the at least three microphone audio signals to a left channel direction based on the at least one metadata directional parameter.

20. The apparatus as claimed in claim 18, wherein the instructions, when executed with the at least one processor, cause the apparatus to generate the second output audio signal as a subtractive combination of the second mix of the at least three microphone audio signals and a panning of the mix of the at least three microphone audio signals to a right channel direction based on the at least one metadata directional parameter.

21. The apparatus as claimed in claim 15, wherein prior to the generated focus audio signal the instructions, when executed with the at least one processor, cause the apparatus to:
de-pan the first audio signal; and
de-pan the second audio signal and to generate the focus audio signal based on a combination of the de-panned first audio signal and the de-panned second audio.

22. The apparatus as claimed in claim 15, wherein the instructions, when executed with the at least one processor, cause the apparatus to:
generate a first output audio signal based on a combination of the focus audio signal and the first audio signal; and
generate a second output audio signal based on a combination of the focus audio signal and the second audio signal.

23. The apparatus as claimed in claim 15, wherein the instructions, when executed with the at least one processor, cause the apparatus to generate the focus audio signal towards the desired focus directional parameter value, the focus audio signal is:
a selection of one of the first audio signal or the second audio signal, where the difference between the at least one metadata directional parameter value and the desired focus directional parameter value is less than a threshold value;
a selection of the other of the first audio signal or the second audio signal, where the difference between the at least one metadata directional parameter value and the desired focus directional parameter value is greater than a further threshold value; and
a mix of the first audio signal or the second audio signal, where the difference between the at least one metadata directional parameter value and the desired focus directional parameter value is less than the further threshold value and more than the threshold value.
